(19) United States
(12) Patent Application Publication
(10) Pub. No.: US 2018/0095693 A1
(43) Pub. Date: Apr. 5, 2018

(54) INFORMATION PROCESSING APPARATUS, INFORMATION PROCESSING SYSTEM, AND METHOD FOR CONTROLLING INFORMATION PROCESSING APPARATUS

(71) Applicant: FUJITSU LIMITED, Kawasaki-shi (JP)

(72) Inventor: Yoshiaki KIKKAWA, Kawasaki (JP)

(73) Assignee: FUJITSU LIMITED, Kawasaki-shi (JP)

(21) Appl. No.: 15/712,781

(22) Filed: Sep. 22, 2017

(30) Foreign Application Priority Data
Oct. 4, 2016 (JP) 2016-196457

(51) Int. Cl. G06F 3/06; G06F 12/02

(52) U.S. Cl. CPC G06F 3/0644; G06F 3/0607; G06F 3/0631; G06F 2212/7209; G06F 3/0652; G06F 12/0246; G06F 3/0683

(57) ABSTRACT

A method for controlling an information processing apparatus including a plurality of electronic parts including an arithmetic processing unit, a control device that controls operations of the plurality of electronic parts, and a memory, where the method includes: detecting that a size of a first area allocated in the memory and retaining setting information of the plurality of electronic parts is different from a size of a setting information area that is newly specified in response to a change in a function of the apparatus; allocating, in response to detection, a second area that is to retain the setting information in place of the first area in the memory; storing, in the second area, valid setting information extracted from the first area; and deleting the first area from the memory after the valid setting information is stored in the second area.

### CROSS-REFERENCE TO RELATED APPLICATION(S)

This application is based upon and claims the benefit of priority of the prior Japanese Patent Application No. 2016-196457, filed on Oct. 4, 2016, the entire contents of which are incorporated herein by reference.

### FIELD

The embodiments discussed herein are related to an information processing apparatus, an information processing system, and a method for controlling an information processing apparatus.

### BACKGROUND

There are cases where, in a computer system including storage systems A and B, the storage system B manages and operates a pool created by the storage system A and a virtual volume that uses the pool. Techniques have been proposed which enable a reduction in the size of a memory area for a copy of the virtual volume in such cases. According to a technique of this type, the storage system B acquires configuration information regarding the pool and the virtual volume of the storage system A and loads the logical volume included in the pool in accordance with the acquired configuration information. The storage system B further converts the acquired configuration information in order to use the configuration information in the storage system B and creates a pool and a virtual volume from the loaded logical volume in accordance with configuration information obtained by the conversion (see, for example, Japanese Laid-open Patent Publication No. 2010-79624).

A technique has been proposed which compares Basic Input/Output System (BIOS) setting information with setting information retained in a backup area and displays an item with different values to allow the user to change the set value when an information processing apparatus is booted (see, for example, Japanese Laid-open Patent Publication No. 2013-140536).

A virtual computer system has been proposed which re-maps addresses of extended read-only memory (ROM) areas for a plurality of virtual computers in accordance with changes in the addresses of the extended ROM areas as a result of a change in the operation mode of a real computer (see, for example, Japanese Laid-open Patent Publication No. 6-222998).

A technique has been proposed which provides a logical server in a backup server in advance and causes the logical server to stand by in a state just before an operating system (OS) is loaded, thereby reducing the time taken for switching of the server compared with the case where creation of the logical server is started upon a failure of an active server (see, for example, Japanese Laid-open Patent Publication No. 2008-293245).

Control devices such as baseboard management controllers (BMCs) installed in respective information processing apparatuses allocate a retaining portion that retains BIOS setting information in a non-volatile memory or the like, in response to the first power-on of the respective information processing apparatuses. For example, information processing apparatuses are powered on for the first time during an assembly process carried out by a manufacturer of the information processing apparatuses.

Thus, if the size of the retaining portion is changed after shipment of the information processing apparatuses, the state of the information processing apparatuses is returned to a pre-shipment state (factory default state) in which the information processing apparatuses are never powered on and then the information processing apparatuses are powered on again. In this case, the control devices such as BMCs determine that this power-on is the first power-on and allocate a retaining portion having a new size defined by firmware or the like in the memory. However, when the state of operating information processing apparatuses are returned to the pre-shipment state, all the information set in the information processing apparatuses is lost. Restoration of the lost information takes time and effort.

An information processing apparatus, an information processing system, a method for controlling an image processing apparatus, and a program for controlling an information processing apparatus according to an aspect of the present disclosure aims to change the size of a retaining portion that retains setting information of electronic parts included in the information processing apparatus without losing information set in the information processing apparatus.

### SUMMARY

According to an aspect of the invention, a method for controlling an information processing apparatus, the information processing apparatus including a plurality of electronic parts including an arithmetic processing unit, a control device that controls operations of the plurality of electronic parts, and a memory device, the method includes: detecting that a size of a first area allocated in the memory device and retaining setting information of the plurality of electronic parts is different from a size of a setting information area that is newly specified in response to a change in a function of the information processing apparatus; allocating, in response to detection, a second area that is to retain the setting information in place of the first area in the memory device, the second area serving as the setting information area; storing, in the second area, valid setting information extracted from the first area; and deleting the first area from the memory device after the valid setting information is stored in the second area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an embodiment of an information processing apparatus and an embodiment of an information processing system;

FIG. 2 is a diagram illustrating an example of an operation of the information processing system illustrated in FIG. 1;

FIG. 3 is a diagram illustrating another embodiment of an information processing apparatus and another embodiment of an information processing system;

FIG. 4 is a diagram illustrating examples of BIOSINF information, BMCINF information, an area management table, and an address management table that are stored in a non-volatile memory NVMS illustrated in FIG. 3;

FIG. 5 is a diagram illustrating an example of a hardware configuration table retained in a non-volatile memory NVMM illustrated in FIG. 3;

FIG. 6 is a diagram illustrating an example of partition information retained in the non-volatile memory NVMM illustrated in FIG. 3;

FIG. 7 is a diagram illustrating an example of functions of firmware MMBFW, firmware BMCFW, and BIOS illustrated in FIG. 3;

FIG. 8 is a diagram illustrating an example of a changing process performed in the information processing system illustrated in FIG. 3 in the case where the number of banks that retain BIOSINF information is increased as a result of unified firmware update;

FIG. 9 is a diagram illustrating a process that follows the process illustrated in FIG. 8;

FIG. 10 is a diagram illustrating a process that follows the process illustrated in FIG. 9;

FIG. 11 is a diagram illustrating an example of the state of the non-volatile memory NVMM before unified firmware update is performed in the information processing system illustrated in FIG. 3;

FIG. 12 is a diagram illustrating an example of the state of each non-volatile memory NVMS before unified firmware update is performed in the information processing system illustrated in FIG. 3;

FIG. 13 is a diagram illustrating an example of the state of each non-volatile memory NVMS in which banks BK3 to BK6 are newly allocated in the information processing system illustrated in FIG. 3;

FIG. 14 is a diagram illustrating an example of the state of the non-volatile memory NVMM in which the hardware configuration table is set to a basic configuration in the information processing system illustrated in FIG. 3;

FIG. 15 is a diagram illustrating an example of the state of each non-volatile memory NVMS in which BIOSINF information and BMCINF information from a management board are stored in the information processing system illustrated in FIG. 3;

FIG. 16 is a diagram illustrating an example of the non-volatile memory NVMM in which banks BK0 and BK1 are deleted and banks BK3 to BK6 are allocated in the information processing system illustrated in FIG. 3;

FIG. 17 is a diagram illustrating an example of the state of each non-volatile memory NVMS in which a variable reclaim process is completed in the information processing system illustrated in FIG. 3;

FIG. 18 is a diagram illustrating an example of the state of each non-volatile memory NVMS in which copying of BIOS setting information from the bank BK0 to the bank BK3 is completed in the information processing system illustrated in FIG. 3;

FIG. 19 is a diagram illustrating an example of the state of the non-volatile memory NVMM in which BIOS setting information transferred from the BMC is stored in the bank BK3 in the information processing system illustrated in FIG. 3;

FIG. 20 is a diagram illustrating an example of the state of each non-volatile memory NVMS in which the area management table has been updated in accordance with deleted banks in the information processing system illustrated in FIG. 3;

FIG. 21 is a diagram illustrating an example of the state of the non-volatile memory NVMM in which the saved hardware configuration table is returned in the information processing system illustrated in FIG. 3;

FIG. 22 is a diagram illustrating an example of the state of each non-volatile memory NVMS after a BIOSINF area extension process is completed in the information processing system illustrated in FIG. 3;

FIG. 23 is a flowchart illustrating an example of a process performed by the BMC in the information processing system illustrated in FIG. 3;

FIG. 24 is a flowchart illustrating a process that follows the process illustrated in FIG. 23;

FIG. 25 is a flowchart illustrating an example of a process performed by the management board in the information processing system illustrated in FIG. 3;

FIG. 26 is a flowchart illustrating a process that follows the process illustrated in FIG. 25;

FIG. 27 is a flowchart illustrating an example of a process performed by the BIOS in the information processing system illustrated in FIG. 3;

FIG. 28 is a flowchart illustrating an example of the variable reclaim process illustrated in FIG. 27;

FIG. 29 is a diagram illustrating an example of an initial operation of the information processing system illustrated in FIG. 3;

FIG. 30 is a diagram illustrating an example of an operation performed in the information processing system illustrated in FIG. 3 when a partition is powered on; and

FIG. 31 is a diagram illustrating an example of an operation performed in the information processing system illustrated in FIG. 3 when a system board is replaced.

### DESCRIPTION OF EMBODIMENTS

Embodiments will be described below with reference to the accompanying drawings.

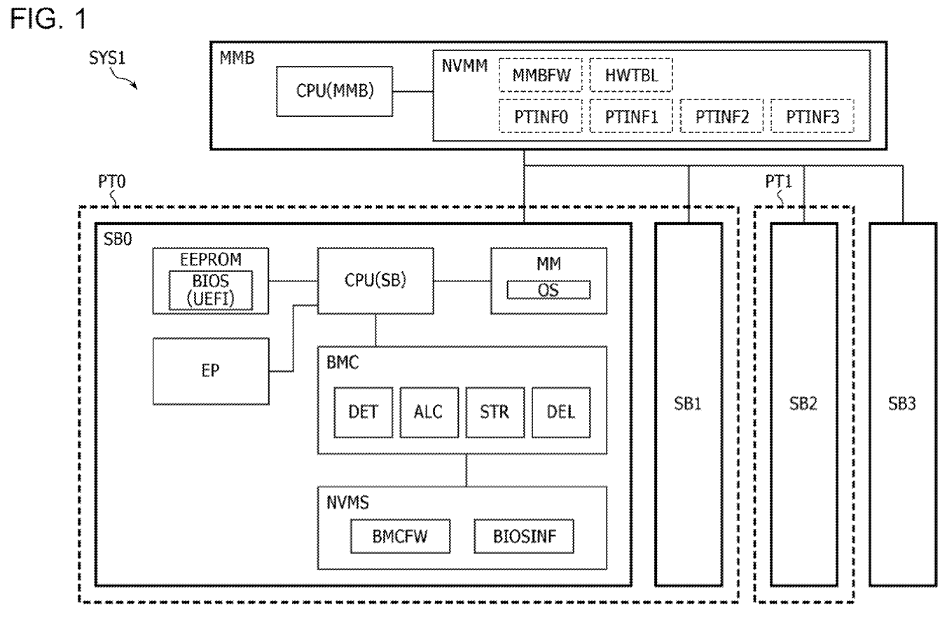

FIG. 1 illustrates an embodiment of an information processing apparatus and an embodiment of an information processing system. An information processing system SYS1 illustrated in FIG. 1 includes a management board MMB and a plurality of system boards SB (SB0, SB1, SB2, and SB3). The number of system boards SB installed in the information processing system SYS1 is not limited to four.

The management board MMB manages the entire information processing system SYS1 and allows the information processing system SYS1 to implement certain functions. The management board MMB also controls the system boards SB and creates partitions PT (PT0 and PT1) by using a certain number of system boards SB. Each of the partitions PT functions as an information processing apparatus that operates independently and serves as a unit of information processing. In the example illustrated in FIG. 1, the partition PT0 is created using the system boards SB0 and SB1, and the partition PT1 is created using the system board SB2.

The management board MMB includes, for example, a central processing unit (CPU), an electrically rewritable non-volatile memory NVMM, a main memory (not illustrated), and a hard disk drive (HDD, not illustrated) and functions as a management server that manages the system boards SB. The management board MMB is an example of a management apparatus that manages the plurality of partitions PT and the plurality of system boards SB. The CPU is an example of an arithmetic processing unit that performs arithmetic processing. The non-volatile memory NVMM includes memory areas each of which stores a corresponding one of firmware MMBFW, a hardware configuration table HWTBL, and partition information PTINF (PTINF0, PTINF1, PTINF2, and PTINF3). The firmware MMBFW is executed by the CPU of the management board MMB.

In the following description, the memory area that stores the partition information PTINF is also referred to as a PTINF area. The number of PTINF areas allocated in the non-volatile memory NVMM is equal to the maximum number of partitions PT that can be created in the information processing system SYS1, and the maximum number of partitions PT is equal to the number of system boards SB.

The firmware MMBFW cooperates with BIOS and firmware BMCFW that are executed in each partition PT and controls operations of the entire information system SYS1. For example, the firmware MMBFW monitors each of the partitions PT, manages power supply, user privilege, and temperature in each of the partitions PT, and manages switching upon a failure of the system board SB. The firmware MMBFW is an example of a control program executed by the management board MMB that controls operations of each of the partitions PT. The non-volatile memory NVMM is an example of a recording medium that stores the firmware MMBFW.

The hardware configuration table HWTBL retains configuration information representing how the system boards SB are assigned to the corresponding partitions PT. The hardware configuration table HWTBL is an example of a configuration information retaining portion. In each PTINF area, the same information as the BIOS information BIOSINF retained in the non-volatile memory NVMS of any of the system boards SB assigned to the corresponding partition PT is stored as backup information. Each PTINF area is an example of a copy retaining portion that retains a copy of the BIOS information BIOSINF used in the corresponding partition PT.

Each of the system boards SB includes a CPU, a main memory MM, a BMC, electronic parts EP, an electrically erasable programmable read-only memory (EEPROM), and an electrically rewritable non-volatile memory NVMS. For example, the non-volatile memory NVMS is a flash memory including a plurality of blocks in which data is independently erasable. The flash memory includes a plurality of memory elements. Through a writing operation, the memory state of each memory element changes from a logical value 1 to a logical value 0. Through an erasing operation performed in a unit of a block including a certain number of memory elements, the memory state of the memory elements changes from the logical value 0 (written state) to the logical value 1 (erased state). The logical value 1 is an example of a first logical value, and the logical value 0 is an example of a second logical value.

Since the system boards SB0 to SB3 have the same configuration, FIG. 1 illustrates the configuration of the system board SB0 alone. In the following description, the CPU of the system boards SB is also referred to as a CPU(SB), and the CPU of the management board MMB is also referred to as a CPU(MMB).

The main memory MM has a memory area that stores an OS executed by the CPU(SB). The EEPROM has a memory area that stores BIOS executed by the CPU(SB). The non-volatile memory NVMS has a memory area that stores the firmware BMCFW executed by the BMC and the BIOS information BIOSINF. The BIOS information BIOSINF includes setting information used to switch between operation specifications of the plurality of electronic parts EP including the CPU(SB) that are mounted on or connected to the system board SB. In the following description, the BIOS information BIOSINF is also referred to as BIOSINF information, and an area storing the BIOS information BIOSINF is also referred to as a BIOSINF area. In addition, setting information included in the BIOSINF information is also referred to as BIOS setting information. For example, the BIOS setting information includes information used to adjust the processing performance and the power consumption of the CPU(SB) and is set through a setup menu that is displayed on the display device when the BIOS is launched.

The BIOS that runs in each partition PT at the time of power-on rewrites the BIOS setting information of each electronic part EP in accordance with modification information input by the user or the like. The BIOS writes new BIOS setting information in the BIOSINF area to rewrite the BIOS setting information. Specifically, the BIOS writes new BIOS setting information in an erased-state area in which no BIOS setting information has been written, and sets an area retaining the old BIOS setting information to an invalid state. In this way, the BIOS rewrites the BIOS setting information.

The CPU(SB) executes the BIOS stored in the EEPROM and the OS stored in the main memory MM to control operations of the system board SB and the partition PT. In addition, the CPU(SB) executes an application program loaded to the main memory MM to implement a desired function for performing data processing or the like. Note that a memory device (not illustrated), such as an HDD, is connected to each of the system boards SB.

The BMC controls power-supply voltage supplied to the CPU(SB) and the frequency of a clock supplied to the CPU(SB), controls operations of the electronic parts EP, or controls access to the non-volatile memory NVMS. The BMC is an example of a control device that controls operations of the plurality of electronic parts EP including the CPU(SB). Various control operations performed by the BMC are implemented as a result of the BMC executing the firmware BMCFW. Thus, the BMC is also a kind of a processor. The firmware BMCFW is an example of a control program executed by the BMC that controls operations of the system board(s) SB in the partition PT. Note that the non-volatile memory NVMS is an example of a recording medium that stores the firmware BMCFW. The BMC executes the firmware BMCFW to function as a detecting unit DET, an allocating unit ALC, a storing unit STR, and a deleting unit DEL. Note that the detecting unit DET, the allocating unit ALC, the storing unit STR, and the deleting unit DEL may be implemented by hardware of the BMC. In addition, the BMC and the non-volatile memory NVMS may be mounted in a single semiconductor chip.

The detecting unit DET detects that the size of the BIOSINF area that retains the setting information of the CPU(SB) and the electronic parts EP differs from the size of a setting information area that is newly specified in response to a change in the function of the partition PT. For example, the change in the function of the partition PT refers to a change, addition, or deletion of the operation mode and occurs in response to integrated (or unified) firmware update for updating the firmware MMBFW, the firmware BMCFW, and the BIOS.

In response to the detecting unit DET detecting a change in the size, the allocating unit ALC allocates a new BIOSINF area that retains setting information in place of the existing BIOSINF area after the change in the function of the partition PT. The existing BIOSINF area is an example of a first area allocated in the non-volatile memory NVMS, and the new BIOSINF area is an example of a second area allocated in the non-volatile memory NVMS.

The storing unit STR stores valid setting information extracted from the existing BIOSINF area in the new BIOSINF area newly added. Note that the valid setting information is extracted from the existing BIOSINF area by the BIOS that manages the setting information stored in the BIOSINF area. The deleting unit DEL deletes the existing BIOSINF area after the valid setting information is stored in the new BIOSINF area.

The BIOS supports the Unified Extensible Firmware Interface (UEFI) and has a function of switching the operation specification of hardware mounted on or connected to the system board SB in accordance with setting information input from the outside. The BIOS is launched in response to power-on of the partition PT and initializes hardware mounted on or connected to the system board SB to set the state of the system board SB to an OS-bootable state. In addition, the BIOS has functions of managing the setting information stored in the BIOSINF area and extracting valid setting information from the setting information retained in the existing BIOSINF area, as described above.

The firmware BMCFW performs a process for sharing information between the management board MMB and the corresponding partition PT after the unified firmware update. The unified firmware update is a process of simultaneously updating the firmware MMBFW, the BIOS, and the firmware BMCFW.

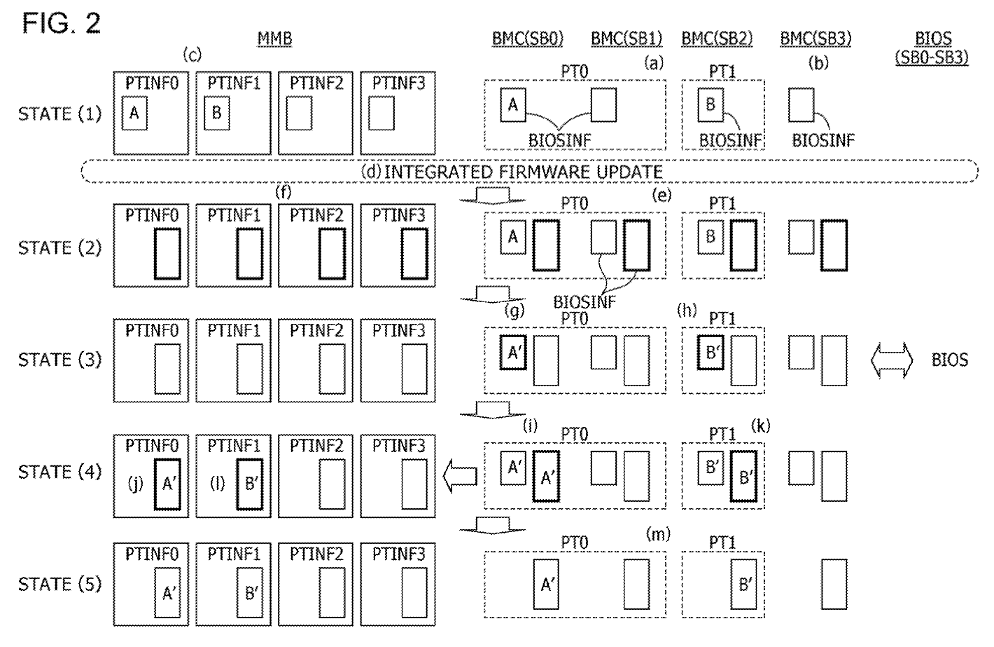

FIG. 2 illustrates an example of an operation of the information processing system SYS1 illustrated in FIG. 1. Operations of the BMC among operations illustrated in FIG. 2 are implemented as a result of the BMC executing the firmware BMCFW. That is, FIG. 2 illustrates an example of an operation based on a method and program for controlling an information processing apparatus. Referring to FIG. 2, each area represented by a thick frame refers to an area in which retained information is changed from the previous state.

A state (1) represents the state of the information processing system SYS1 before unified firmware update is performed. In the state (1), the information processing system SYS1 has the partition PT0 assigned the system boards SB0 and SB1 and the partition PT1 assigned the system board SB2 as illustrated in FIG. 1 ((a) in FIG. 2). The system board SB3 is not assigned to any partition PT ((b) in FIG. 2).

BIOS setting information A of the partition PT0 is retained in a BIOSINF area of the system board SB0 (home system board) among the system boards SB0 and SB1 assigned to the partition PT0. BIOS setting information B of the partition PT1 is retained in a BIOSINF area of the system board SB2 (home system board) assigned to the partition PT1. In addition, in the management board MMB, a PTINF0 area corresponding to the partition PT0 retains a copy of the BIOS setting information A of the partition PT0 ((c) in FIG. 2). A PTINF1 area corresponding to the partition PT1 retains a copy of the BIOS setting information B of the partition PT1.

In response to unified firmware update for changing the function of each partition PT (each system board SB), the BIOS and the firmware BMCFW of the system board SB are updated ((d) in FIG. 2). It is assumed that the size of the new BIOSINF area is greater than the size of the existing BIOSINF area. The size of the new BIOSINF area is written and specified in the updated firmware BMCFW.

In a state (2), the detecting unit DET of the firmware BMCFW of each system board SB compares the size of the new BIOSINF area written in the firmware BMCFW with the size of the existing BIOSINF area (details will be described later). The detecting unit DET then detects that the size of the new BIOSINF area differs from the size of the existing BIOSINF area. In response to the detecting unit DET detecting the difference in size, the allocating unit ALC of the firmware BMCFW allocates the new BIOSINF area in the non-volatile memory NVMS ((e) in FIG. 2). The new BIOSINF area newly added in the non-volatile memory NVMS is an example of a corresponding area corresponding to a new BIOSINF area newly added in the non-volatile memory NVMS.

In response to addition of the new BIOSINF area in the non-volatile memory NVMS, the firmware MMBFW of the management board MMB acquires the size of the existing BIOSINF area and the size of the new BIOSINF area from the BMC of each system board SB. The firmware MMBFW of the management board MMB then deletes an area corresponding to the existing BIOSINF area and allocates an area of a size equal to the size of the new BIOSINF area in each PTINF area ((f) in FIG. 2).

Then, in a state (3), the firmware MMBFW instructs the BMC to power on each partition PT. The BMCs (firmware BMCFW) in the home system boards SB of the partitions PT0 and PT1 power on the partitions PT0 and PT1, and consequently the BIOS of the partition PT0 and the BIOS of the PT1 are launched, respectively. The BIOS of the partition PT0 extracts valid BIOS setting information A′ from the existing BIOSINF area and rewrites the existing BIOSINF area with the extracted valid BIOS setting information A′ ((g) in FIG. 2) (details will be described later). The BIOS of the partition PT1 extracts valid BIOS setting information B′ from the existing BIOSINF area and rewrites the existing BIOSINF area with the extracted valid BIOS setting information B′ ((h) in FIG. 2).

A process of extracting the valid BIOS setting information from the existing BIOSINF area and rewriting the existing BIOSINF area with the extracted valid BIOS setting information can be performed using an existing function of the BIOS (details will be described later). Then, each of the BIOS of the partition PT0 and the BIOS of the partition PT1 instructs the corresponding BMC to copy the valid BIOS setting information (A′ or B′) retained in the existing BIOSINF area to the new BIOSINF area.

Then, in a state (4), in response to the instruction from the BIOS, the BMC in the home system board SB of the partition PT0 stores the valid BIOS setting information A′ retained in the existing BIOSINF area in the new BIOSINF area ((i) in FIG. 2). The storing unit STR of the firmware BMCFW performs storage of the BIOS setting information A′ in the new BIOSINF area. In addition, the BMC in the home system board SB of the partition PT0 instructs the management board MMB to store the BIOS setting information A′ stored in the new BIOSINF area in the PTINF0 area. In response to the instruction from the BMC, the management board MMB stores the BIOS setting information A′ in the PTINF0 area ((j) in FIG. 2).

Likewise, in response to the instruction from the BIOS, the BMC in the home system board SB of the partition PT1 stores the valid BIOS setting information B′ retained in the existing BIOSINF area in the new BIOSINF area ((k) in FIG. 2). The storing unit STR of the firmware BMCFW performs storage of the BIOS setting information B′ in the new BIOSINF area. In addition, the BMC in the home system board SB of the partition PT1 instructs the management board MMB to store the BIOS setting information B′ stored in the new BIOSINF area in the PTINF1 area. In response to the instruction from the BMC, the management board MMB stores the BIOS setting information B′ in the PTINF1 area ((l) in FIG. 2).

Then, in a state (5), the deleting unit DEL of the firmware BMCFW of each of the system boards SB0 to SB3 deletes the existing BIOSINF area ((m) in FIG. 2). Thereafter, the partitions PT0 and PT1 uses the new BIOSINF area to which the valid BIOS setting information A′ is copied and the new BIOSINF area to which the valid BIOS setting information B′ is copied as existing BIOSINF areas, respectively. Through the operation described above, the existing BIOSINF area used before the unified firmware update is successfully switched to a BIOSINF area having a new size. In addition, in response to a change in size of the BIOSINF area, an area having the size of the new BIOSINF area is successfully allocated in each PTINF area of the management board MMB.

An example in which the size of the new BIOSINF area is greater than the size of the existing BIOSINF area has been described using FIG. 2. However, FIG. 2 is also applicable to the case where the size of the new BIOSINF area is smaller than the size of the existing BIOSINF area. In this case, the BIOS first selects BIOS setting information to be retained in a BIOSINF area of a reduced size and extracts valid setting information from the selected BIOS setting information in the state (3).

Further, in the state (3) of FIG. 2, the BIOS may store the valid BIOS setting information extracted from the existing BIOSINF area directly in the new BIOSINF area instead of the existing BIOSINF area. In this case, a process of copying the valid BIOS setting information from the existing BIOSINF area to the new BIOSINF area, which is performed in the state (4), can be omitted. If the BIOS does not have a function of storing the valid BIOS setting information extracted from the existing BIOSINF area in the new BIOSINF area, a new function is added to a storage process performed by the BIOS at the time of the unified firmware update.

As described above, in the embodiment illustrated in FIGS. 1 and 2, in the case where the size of the BIOSINF area is changed, a new BIOSINF area is allocated, valid setting information is extracted from the existing BIOSINF area, and the extracted valid setting information is stored in the new BIOSINF area. With this configuration, the size of the BIOSINF areas of all the system boards SB are successfully changed, without returning the state of the information processing system SYS1 to the pre-shipment state (factory default state). That is, the size of the BIOSINF area that retains setting information of the electronic parts EP of the system boards SB is successfully changed, without losing information set in the corresponding partitions PT (system boards SB). Since the size of the BIOSINF area is successfully changed without human intervention, the time and effort for restoring the lost information may be omitted and human error relating to the settings may be avoided.

The management board MMB acquires the size of the existing BIOSINF area and the size of the new BIOSINF area from the BMC of each system board SB, deletes the area corresponding to the existing BIOSINF area, and allocates an area corresponding to the new BIOSINF area in the corresponding PTINF area. The management board MMB then stores the valid setting information transferred from the BIOS in the area newly allocated in the corresponding PTINF area. By reflecting the BIOSINF area having a changed size in the PTINF area in the non-volatile memory NVMM of the management board MMB, the BIOS setting information that is to be changed by the BIOS later is successfully backed up in the PTINF area.

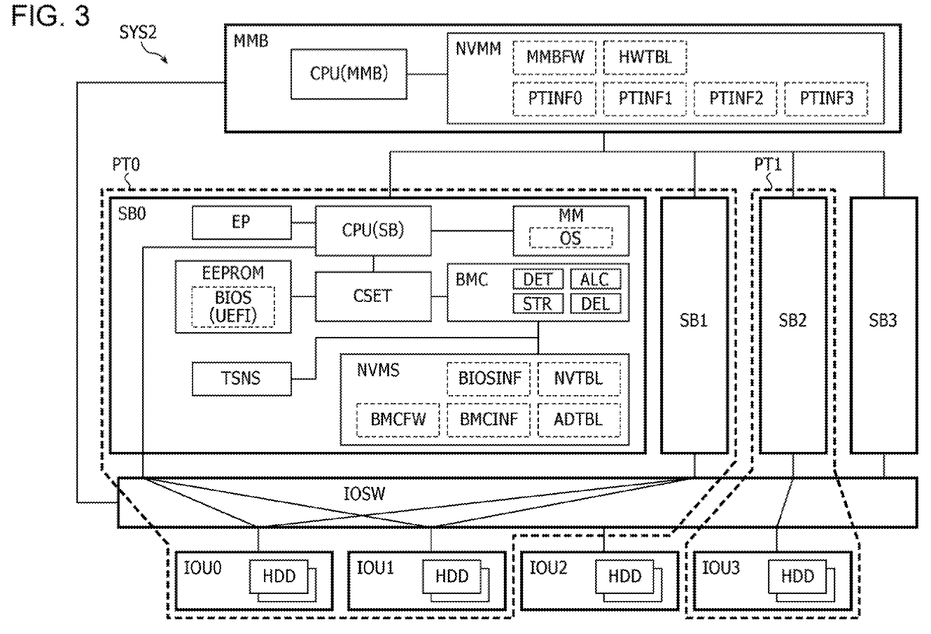

FIG. 3 illustrates more in detail the embodiment described in FIGS. 1 and 2. Components that are the same or substantially the same as the components described in the embodiment illustrated in FIG. 1 are assigned the same reference signs, and a detailed description of these components is omitted.

An information processing system SYS2 illustrated in FIG. 3 includes a management board MMB, a plurality of system boards SB (SB0, SB1, SB2, and SB3), an input/output switch IOSW, and a plurality of input/output units IOU (IOU0, IOU1, IOU2, and IOU3). Note that the number of system boards SB and the number of input/output units IOU included in the information processing system SYS2 are not limited to four.

The management board MMB controls the system boards SB and the input/output switch IOSW and connects a certain number of system boards SB to a certain number of input/output units IOU via the input/output switch IOSW to create partitions PT (PT0 and PT1). Each of the partitions PT functions as an information processing apparatus that operates independently from each other. In the example illustrated in FIG. 3, the partition PT0 is created using the system boards SB0 and SB1 and the input/output units IOU0 and IOU1, and the partition PT1 is created using the system board SB2 and the input/output unit IOU3. In the case where the number of input/output units IOU is greater than or equal to the number of system boards SB, the maximum number of partitions PT that can be created in the information processing system SYS2 is equal to the number of system boards SB. That is, the maximum number of partitions PT that can be created in the information processing system SYS2 illustrated in FIG. 3 is “4”.

The management board MMB includes, for example, a CPU(MMB), a non-volatile memory NVMM, a main memory (not illustrated), and an HDD (not illustrated) and functions as a management server that manages the system boards SB and the input/output switch IOSW. The non-volatile memory NVMM has memory areas each of which stores one of firmware MMBFW, a hardware configuration table HWTBL, and partition information PTINF (PTINF0, PTINF1, PTINF2, and PTINF3). The number of PTINF areas allocated in the non-volatile memory NVMM is equal to the maximum number of partitions PT that can be created in the information processing system SYS2. For example, the non-volatile memory NVMM is a flash memory including a plurality of blocks in which data is independently erasable.

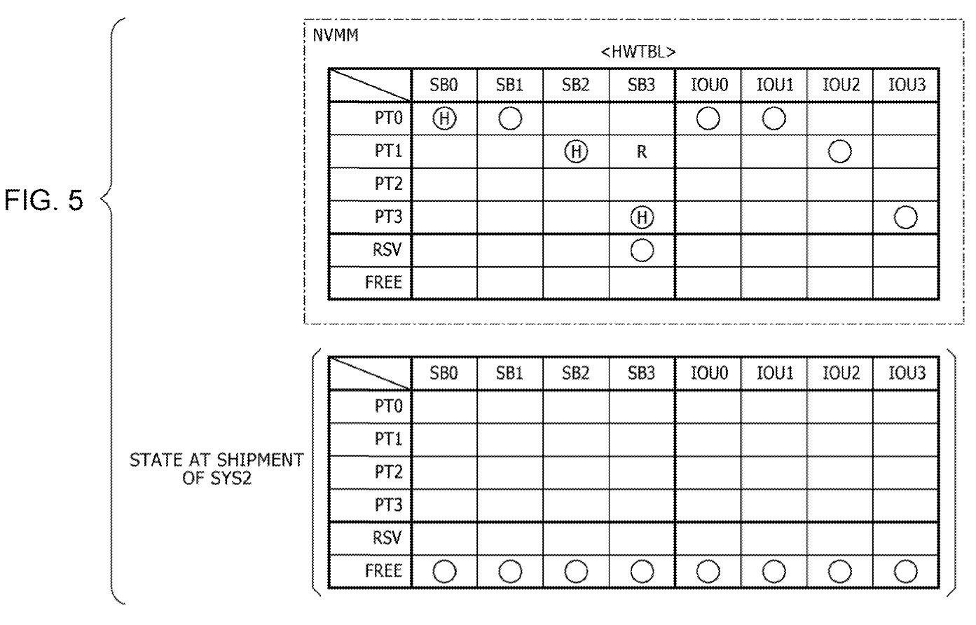

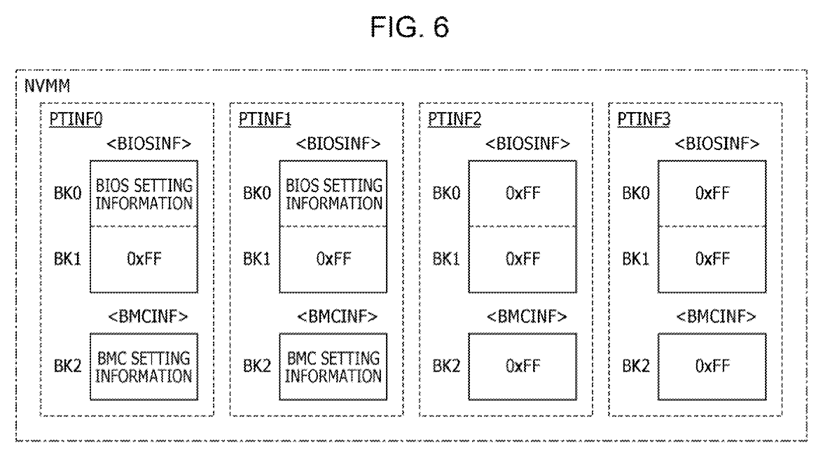

FIG. 5 illustrates an example of the hardware configuration table HWTBL. In each PTINF area, the same information as BIOS information BIOSINF and the same information as BMC information BMCINF that are retained in the non-volatile memory NVMS of the system board SB (home system board described later) assigned to the corresponding partition PT are stored. FIG. 6 illustrates an example of the partition information PTINF.

Each of the system boards SB includes a CPU(SB), electronic parts EP, a main memory MM, a chipset CSET, a BMC, an EEPROM, a non-volatile memory NVMS, and a temperature sensor TSNS. For example, the electronic parts EP include a Serial Attached Small Computer System Interface (SCSI) (SAS)/Serial Advanced Technology Attachment (SATA) controller or a network interface card (NIC). For example, the non-volatile memory NVMS is a flash memory including a plurality of blocks in which data is independently erasable. Since the system boards SB0 to SB3 have the same configuration, FIG. 3 illustrates the configuration of the system board SB0 alone.

The non-volatile memory NVMS has memory areas each of which stores one of firmware BMCFW executed by the BMC, BIOS information BIOSINF, BMC information BMCINF, an area management table NVTBL, and an address management table ADTBL. In the following description, the BMC information BMCINF is also referred to as BMCINF information, and an area storing the BMC information BMCINF is also referred to as a BMCINF area.

The CPU(SB) has a function of an input/output interface that controls data transfer performed between the system board SB and the input/output unit IOU and is connected to the input/output unit IOU via the input/output switch IOSW. In the case where the partition PT includes a plurality of system boards SB, one of the system boards SB operates as a home system board SB and controls operations of the entire partition PT. The system boards SB other than the home system board SB are dedicated for execution of data processing based on an application program. The BIOSINF area, the BMCINF area, the area management table NVTBL, and the address management table ADTBL are allocated in the non-volatile memories NVMS of all the system boards SB.

The chipset CSET is connected to the CPU(SB), the EEPROM, and the BMC and controls input/output of information among the CPU(SB), the EEPROM, and the BMC. The BMC controls power-supply voltage supplied to the CPU(SB), the frequency of a clock supplied to the CPU(SB), and the number of revolutions of a fan (not illustrated) in accordance with temperature measured by the temperature sensor TSNS. Various control operations performed by the BMC are implemented as a result of the BMC executing the firmware BMCFW. The BMC executes the firmware BMCFW to function as a detecting unit DET, an allocating unit ALC, a storing unit STR, and a deleting unit DEL. Note that the BMC and the non-volatile memory NVMS may be mounted in a single semiconductor chip.

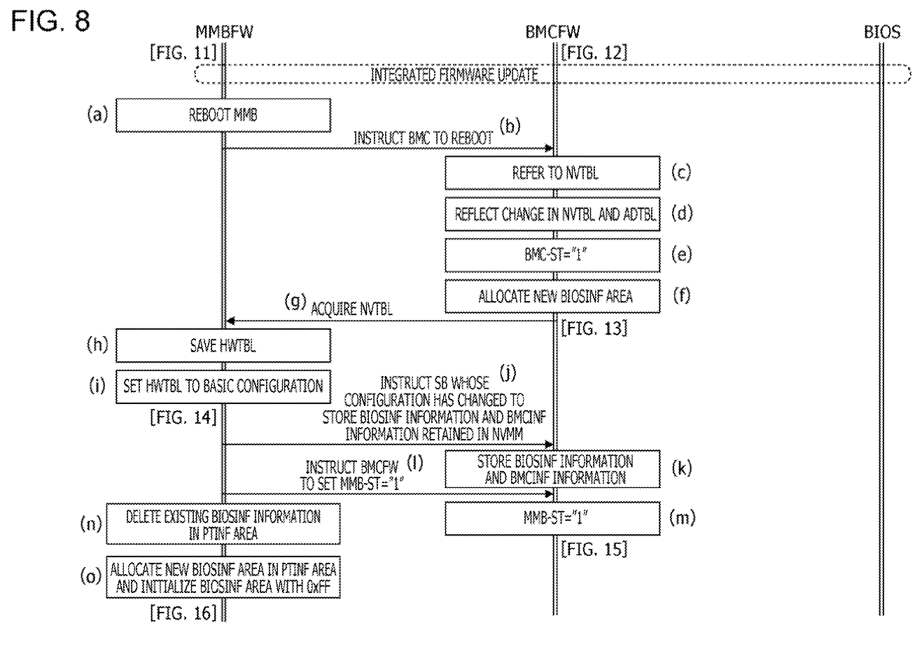

The firmware BMCFW performs a process for sharing information between the management board MMB and the corresponding partition PT after the unified firmware update. An example of the process performed by the firmware BMCFW is illustrated in FIGS. 8 to 10 and 23 and 24.

The BIOSINF information includes BIOS setting information used for switching between operation specifications of the plurality of electronic parts EP including the CPU(SB) that are mounted on or connected to the system board SB. The BMCINF information includes setting information, such as a watchdog setting for monitoring that the OS is operating. In the following description, the setting information included in the BMCINF information is also referred to as BMC setting information.

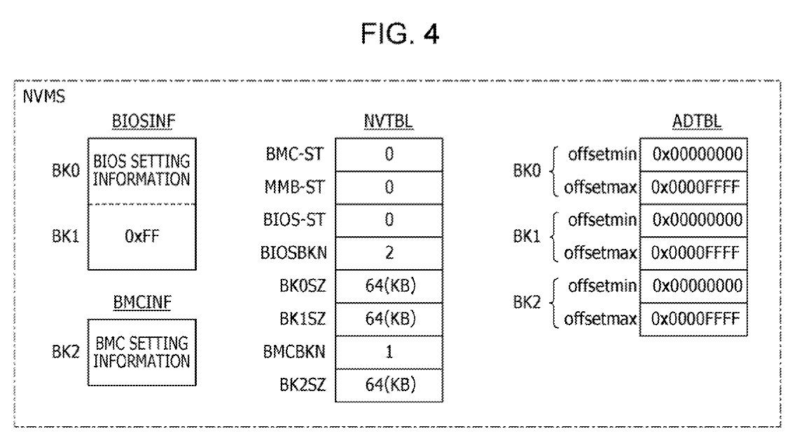

The area management table NVTBL stores information concerning the size of the BIOSINF area and the size of the BMCINF area. The address management table ADTBL stores address information used for accessing the BIOSINF area and the BMCINF area. FIG. 4 illustrates an example of the area management table NVTBL and an example of the address management table ADTBL.

In accordance with control performed by the management board MMB, the input/output switch IOSW connects the system board(s) SB of each partition PT to a certain number of input/output units IOU. Each of the input/output units IOU includes a plurality of HDDs. Alternatively, each of the input/output units IOUs may include a plurality of solid state drives (SSDs). In addition, the information processing systems SYS2 may include input/output units IOU each including HDDs and input/output units IOUs each including SSDs.

FIG. 4 illustrates examples of the BIOSINF information, the BMCINF information, the area management table NVTBL, and the address management table ADTBL that are retained in the non-volatile memory NVMS illustrated in FIG. 3. Referring to FIG. 4, the BIOSINF area that retains the BIOS setting information of the electronic parts EP is assigned to two banks BK0 and BK1, and the BMCINF area that retains the BMC setting information is assigned to a bank BK2.

For example, the BIOS setting information is stored in the bank BK0 of the BIOSINF area. If the BIOS setting information is updated (changed) by the BIOS that runs when the partition PT is booted, the new BIOS setting information is stored (written) in a new area in the bank BK0. This is done because the memory state of memory elements of the non-volatile memory NVMS (flash memory) only changes from an erased state (logical value 1) to a written state (logical value 0) through a writing operation, and the written state changes to the erased state in a unit of a block through an erasing operation. For example, in the non-volatile memory NVMS, a binary value “1110” is rewritable to a binary value “1010” but the binary value “1010” is not rewritable to the binary value “1110”. Rewriting from “1010” to “1110” is performed after “1010” is set to “1111” through the erasing operation.

Because of such writing characteristics of flash memories, the new BIOS setting information is written in an erased-state area in the bank BK0 every time the BIOS setting information is updated. Thus, every time the BIOS setting information is updated, the invalid BIOS setting information accumulates in the bank BK0, and the available area in the bank BK0 gradually decreases. Whether the BIOS setting information stored in the BIOSINF area is valid or invalid is determined based on a valid flag, for example.

When the BIOS detects that the available area in the bank BK0 is smaller than or equal to a certain size, the BIOS extracts valid BIOS setting information (latest BIOS setting information) from the bank BK0 and stores the extracted BIOS setting information in the bank BK1. After performing the erasing operation on the bank BK0, the BIOS writes back the valid BIOS setting information retained in the bank BK1 to the bank BK0. In this way, invalid BIOS setting information is erased from the bank BK0. The erasing operation is performed on the bank BK1 after the valid BIOS setting information is written back to the bank BK0, and data is reset to 0xFF (having 1 at all digits).

A process of erasing invalid BIOS setting information except for valid BIOS setting information included in the BIOSINF information is referred to as “variable reclaim”. The variable reclaim process is performed in a period of a power-on self-test (POST) that is executed by the BIOS when the BIOS is launched. For example, each of the banks BK (BK0, BK1, and BK2) has a size equal to the size of a block that is a unit in which data is erased, and data is erasable for each bank BK. Note that each bank BK may include a plurality of blocks.

The area management table NVTBL has areas that retain state flags BMC-ST, MMB-ST, and BIOS-ST; the number of banks BIOSBKN; the bank sizes BK0SZ and BK0SZ; the number of banks BMCBKN; and the bank size BK0SZ. The state BMC-ST represents the state of the BMC, the state MMB-ST represents the state of the management board MMB, and the state BIOS-ST represents the state of the BIOS. The states BMC-ST, MMB-ST, and BIOS-ST are used by the management board MMB, the BMC, and the BIOS to perform a changing process in cooperation with one another when the number of banks BK for storing the BIOSINF information is changed in response to unified firmware update. Note that the state flags BMC-ST, MMB-ST, and BIOS-ST may be retained in the BMC.

The state BMC-ST is set to “1” (switching state) while a switching process is being performed in response to a change in size of the BIOSINF area. An area retaining the state BMC-ST is an example of a first state retaining portion that retains a switching state indicating that an existing bank BK is being switched to a new bank BK.

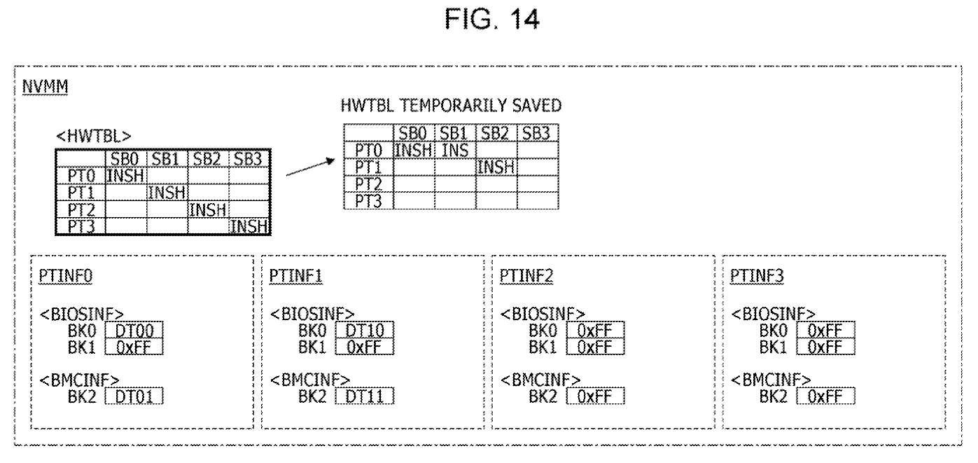

The state MMB-ST is set to “1” while a switching process is being performed in response to a change in size of the bank BK. For example, the state MMB-ST is set to “1” for a period in which all the system boards SB are assigned to the respective partitions PT as the home system boards SB in accordance with the hardware configuration table HWTBL that is set to a basic configuration described with reference to FIG. 14.

The state BIOS-ST is set to “1” (extracting state) while the BIOS is extracting the valid BIOS setting information. In addition, the state BIOS-ST is set to “2” (copying state) while the BIOS is copying the valid BIOS setting information in the bank BK0 or BK1 to banks BK3 to BK6. Further, the state BIOS-ST is set to “0” (idle state) when the BIOS is neither in the extracting state nor the copying state. An area retaining the state BIOS-ST is an example of a second state retaining portion indicating the operation state of the BIOS.

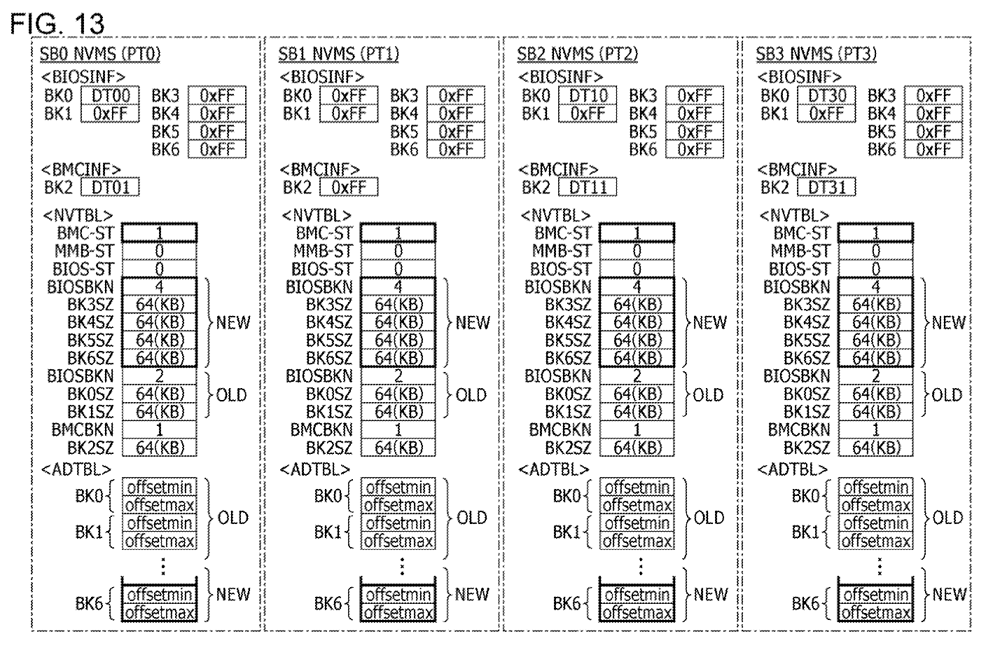

The number of banks BIOSBKN represents the number of banks BK assigned to the BIOSINF area, the bank size BK0SZ represents the size of the bank BK0, and the bank size BK1SZ represents the size of the bank BK1. The number of banks BMCBKN represents the number of banks assigned to the BMCINF area, and the bank size BK2SZ represents the size of the bank BK2. For example, the size of each bank BK is equal to 64 kilobytes (KB). The bank sizes BK0SZ and BK1SZ are an example of first size information representing the sizes of the banks BK0 and BK1 assigned to the BIOSINF area, respectively. The area management table NVTBL is an example of a size information retaining portion that retains the bank sizes BK0SZ and BK1SZ and bank sizes BK3SZ to BK6SZ illustrated in FIG. 13. Note that the size of the area management table NVTBL changes depending on the number of banks BK assigned to the BIOSINF area and the number of banks assigned to the BMCINF area.

The address management table ADTBL has an area that retains, for each of the banks BK0 to BK2, an offset value offsetmin of the start address of the bank and an offset value offsetmax of the end address of the bank. Referring to FIG. 4, the offset values offsetmin and offsetmax are represented in 32 bits. The size of each of the banks BK0 to BK2, which is represented by a difference between the offset values offsetmin and offsetmax, is equal to the size represented by a corresponding one of the bank sizes BK0SZ, BK1SZ, and BK2SZ of the area management table NVTBL. For example, the area management table NVTBL and the address management table ADTBL are assigned blocks different from the blocks assigned to the banks BK0 to BK2. The address management table ADTBL is an example of an address information retaining portion that retains the offset values offsetmin and offsetmax representing the addresses assigned to each of the banks BK0 and BK1. The offset values offsetmin and offsetmax of each of the banks BK0 and BK1 is an example of first address information.

FIG. 5 illustrates an example of the hardware configuration table HWTBL retained in the non-volatile memory NVMM illustrated in FIG. 3. The hardware configuration table HWTBL has, for each system board SB, fields of the partitions PT0 to PT3, reserved RSV, and free FREE. The hardware configuration table HWTBL also has, for each input/output unit IOU, fields of the partitions PT0 to PT3, reserved RSV, and free FREE.

Referring to FIG. 5, a circle in a field specified by the system board SB and the partition PT indicates that the system board SB is assigned to the partition PT. A circle having “H” therein indicates that the system board SB is assigned to the partition PT as the home system board SB.

A circle in the reserve RSV field indicates that the system board SB or the input/output unit IOU is reserved for replacement. A circle is written in the free FREE field when there is the system board SB or the input/output unit IOU not in use. In the hardware configuration table HWTBL practically used, for example, “1” is stored instead of the circle, “2” is stored instead of the circle having “H” therein, and “0” is stored instead of the blank.

FIG. 5 illustrates the state where the partitions PT0, PT1, and PT3 are created. The system boards SB0 and SB1 are assigned to the partition PT0, and the system board SB0 is the home system board SB. The system board SB2 is assigned to the partition PT1 as the home system board SB. The system board SB3 is reserved for replacement. No system board SB is assigned to the partition PT2. The system board SB3 is assigned to the partition PT3 as the home system board SB.

If a failure occurs in the system board SB2 of the partition PT1, the partition PT1 is powered off, the reserved system board SB3 is assigned as the home system board SB of the partition PT1, and the partition PT1 is powered on again. In the case where the partition PT3 is powered when a failure occurs in the system board SB2, the partition PT3 is powered off and the system board SB3 is assigned to the partition PT1 after assignment to the partition PT3 is terminated. By including the reserve RSV field in the hardware configuration table HWTBL, the system board SB3 is successfully assigned to the partition PT1 automatically when a failure occurs in the system board SB2. In contrast, if the hardware configuration table HWTBL does not include the reserve RSV field, the replacement system board SB is specified from the outside of the information processing system SYS2 and the hardware configuration table HWTBL is rewritten in accordance with the specification from the outside.

The hardware configuration table HWTBL in parentheses at the lower part of FIG. 5 represents the state of the information processing system SYS2 at the time of shipment. At the time of shipment of the information processing system SYS2, all the system boards SB and all the input/output units IOU are set to the not-in-use state (FREE) in the hardware configuration table HWTBL.

FIG. 6 illustrates an example of the partition information PTINF retained in the non-volatile memory NVMM illustrated in FIG. 3. FIG. 6 illustrates the state of the partition information PTINF of the information processing system SYS2 of FIG. 3 in which the partitions PT0 and PT1 are created.

In a PTINF0 area corresponding to the partition PT0, areas having the same sizes as the banks BK0, BK1, and BK2 are allocated as in the non-volatile memory NVMS (FIG. 4) of the home system board SB0 of the partition PT0. The firmware MMBFW refers to the area management table NVTBL of the partition PT0 to allocate the areas corresponding to the banks BK0 to BK2 in the PTINF0 area. Then, in the PTINF0 area, the same information as the BIOSINF information and the same information as the BMCINF information that are retained in the non-volatile memory NVMS of the home system board SB of the partition PT0 are retained as backup. As described with reference to FIG. 4, the bank BK1 is used for temporarily retaining the extracted valid BIOS setting information during the “variable reclaim” process. Thus, the bank BK1 is in the erased state (0xFF) except for the period of the “variable reclaim” process.

Likewise, in a PTINF1 area corresponding to the partition PT1, the same information as the BOIS setting information and the same information as the BMC setting information that are retained in the non-volatile memory NVMS of the home system board SB2 of the partition PT1 are retained as backup. The partitions PT2 and PT3 are not created in the information processing system SYS2. Thus, the same information as that of the banks BK0, BK1, and BK2 that are initialized to “0xFF” is retained in a PTINF2 area corresponding to the partition PT2 and a PTINF3 area corresponding to the partition PT3 as backup.

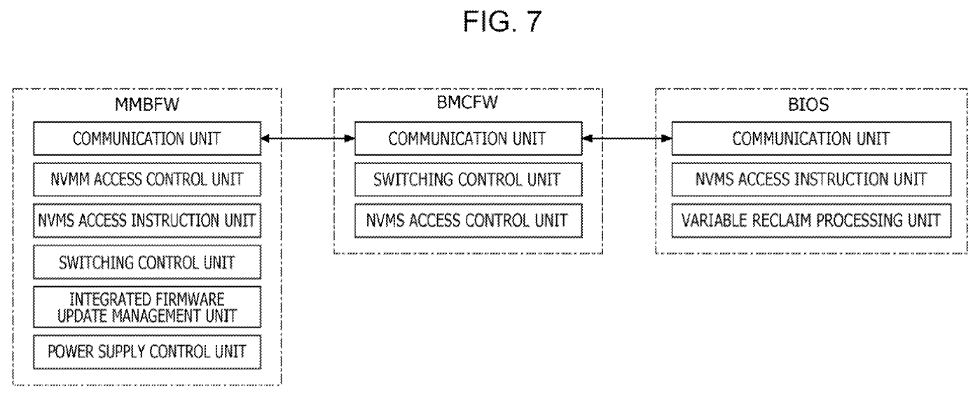

FIG. 7 illustrates an example of functions of the firmware MMBFW, the firmware BMCFW, and the BIOS illustrated in FIG. 3. The firmware MMBFW includes a communication unit that controls communication with the firmware BMCFW, and the firmware BMCFW includes a communication unit that controls communication with the firmware MMBFW and the BIOS. The BIOS includes a communication unit that controls communication with the firmware BMCFW. Each of the communication units performs communication in accordance with the Intelligent Platform Management Interface (IPMI) standard.

The firmware MMBFW includes an NVMM access control unit that controls access to the non-volatile memory NVMM and an NVMS access instruction unit that instructs the system board SB to access the non-volatile memory NVMS. In addition, the firmware MMBFW includes a switching control unit that controls a BIOSINF area switching process (described later), an unified firmware update management unit that manages an unified firmware update process, and a power supply control unit that controls power supply to each partition PT.

The firmware BMCFW includes an NVMS access control unit that controls access to the non-volatile memory NVMS of the system board SB and a switching control unit that controls the BIOSINF area switching process (described later). The BIOS includes an NVMS access instruction unit that instructs the system board SB to access the non-volatile memory NVMS and a variable reclaim processing unit that performs a variable reclaim process.

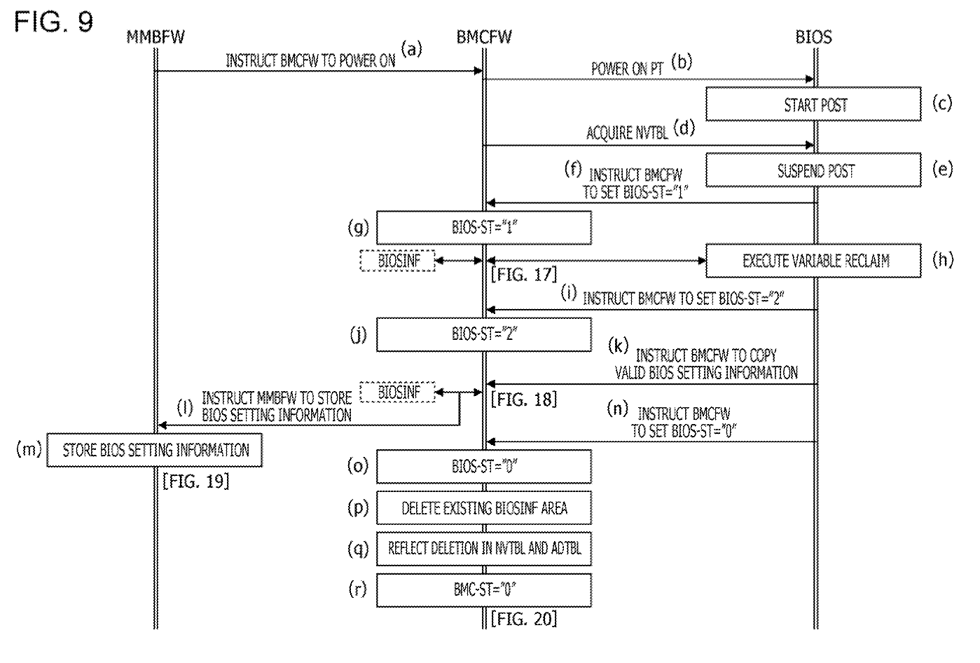

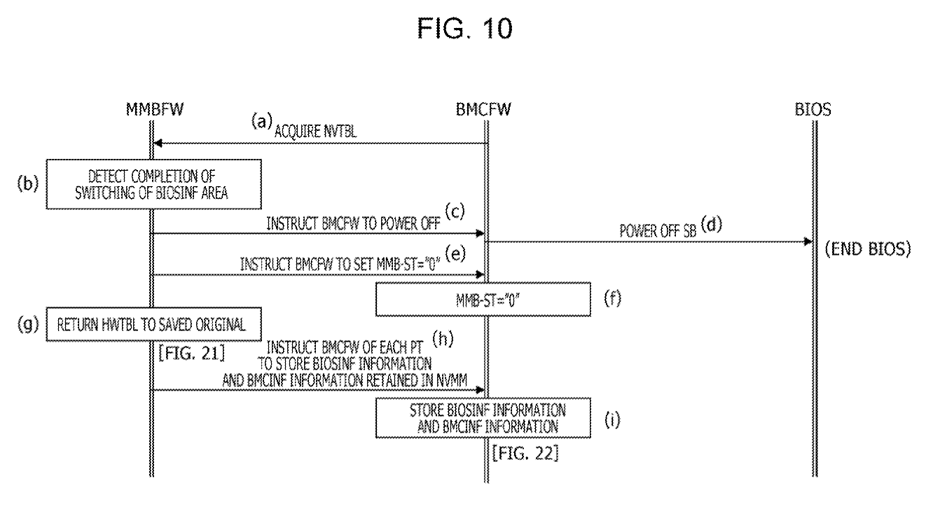

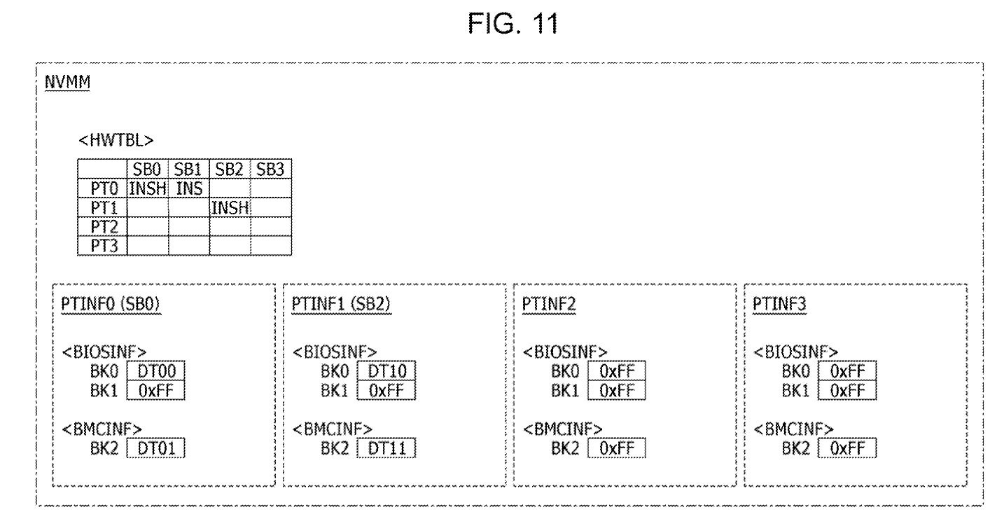

FIGS. 8 to 10 illustrate an example of a changing process performed in the information processing system SYS2 illustrated in FIG. 3 when the number of banks BK that retain the BIOSINF information is increased as a result of unified firmware update. That is, FIGS. 8 to 10 illustrate an example of the BIOSINF area switching process. FIG. 9 illustrates the process that follows the process illustrated in FIG. 8, and FIG. 10 illustrates the process that follows the process illustrated in FIG. 9. FIGS. 11 to 22 illustrate an example of how information retained in the non-volatile memories NVMM and NVMS are changed. Referring to FIGS. 11 to 22, each area represented by a thick frame indicates an area in which retained information is changed from the previous state. In FIGS. 8 to 10, the operation of the firmware MMBFW represents the operation of the management board MMB, and the operation of the firmware BMCFW represents the operation of the BMC. A process performed by the firmware BMCFW is an example of a method for controlling an information processing apparatus.

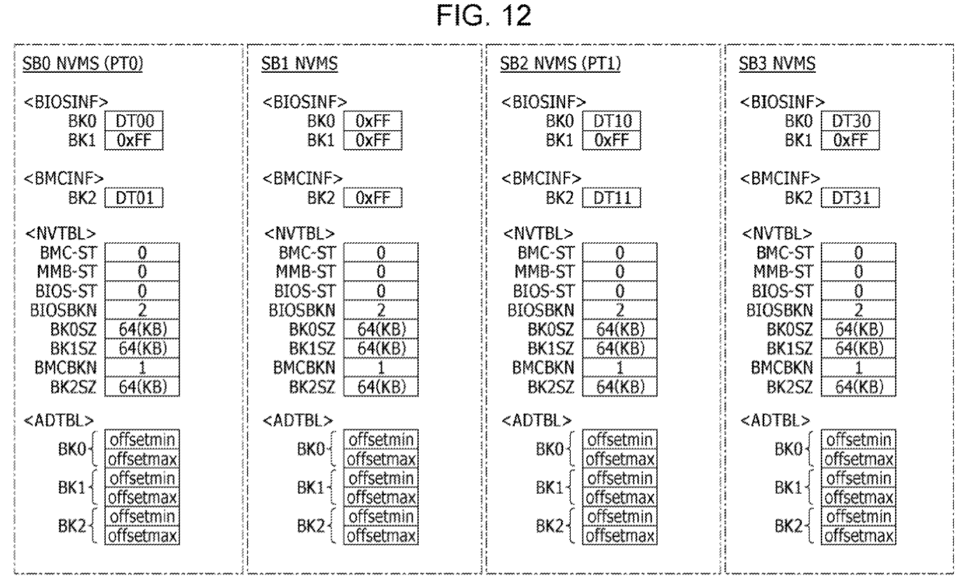

The state of the information processing system SYS2 before unified firmware update is the same as that of FIG. 3. That is, the system boards SB0 and SB1 are assigned to the partition PT0, and the system board SB2 is assigned to the partition PT1. The state of the non-volatile memory NVMM of the management board MMB before the unified firmware update is illustrated in FIG. 11, and the state of the non-volatile memory NVMS of each system board SB before the unified firmware update is illustrated in FIG. 12. In FIGS. 11 and 12, data DT00 represents the BIOS setting information of the partition PT0, and data DT01 represents the BMC setting information of the partition PT0. Data DT10 represents the BIOS setting information of the partition PT1, and data DT11 represents the BMC setting information of the partition PT1. Data DT30 represents the BIOS setting information set when the system board SB3 was assigned to one of the partitions PT in the past, and data DT31 represents the BMC setting information set when the system board SB3 was assigned to one of the partitions PT in the past. The data DT30 and the data DT31 are invalid information.

In FIG. 11, the PTINF2 area and the PTINF3 respectively corresponding to the partitions PT2 and PT3 that are not in use are initialized to 1 (0xFF) and are kept in the initialized state. In FIG. 12, since the system board SB1 assigned to the partition PT0 is not the home system board SB, the BIOSINF area (BK0 and BK1) and the BMCINF area (BK2) are initialized to 1 (0xFF) and are kept in the initialized state. Information common to the information processing system SYS2 is stored in the area management table NVTBL and the address management table ADTBL of the system boards SB. That is, the number of banks that store the BIOSINF information and the number of banks BK that store the BMCINF information are set in accordance with the functions of the information processing system SYS2. Further, the number of banks BK that store the BIOSINF information is changed in response to a change in the functions of the information processing system SYS2 in response to unified firmware update.

Referring back to FIG. 8, after the unified firmware update, the firmware MMBFW reboots the management board MMB ((a) in FIG. 8). The firmware MMBFW then instructs the BMC of each system board SB to reboot and starts communicating with each system board SB ((b) in FIG. 8). After rebooting the BMC, the firmware BMCFW of each system board SB refers to the number of banks BIOSBKN retained in the area management table NVTBL ((c) in FIG. 8). The number of banks BIOSBKN represents the number of banks BK allocated for retaining the existing BIOSINF information. The detecting unit DET of the firmware BMCFW detects that the number of banks BK newly specified by the firmware BMCFW to retain the BIOSINF information differs from the number of banks BIOSBKN. That is, the detecting unit DET of the firmware BMCFW detects that the size of the BIOSINF area that newly retains the BIOS setting information differs from the size of the existing BIOSINF area retained in the area management table NVTBL. The size of the new BIOSINF area may be greater than or smaller than the size of the existing BIOSINF area. For example, the number of new banks BK specified by the firmware BMCFW is written in the firmware BMCFW.

The firmware BMCFW of each system board SB adds information representing the new BIOSINF area to be allocated to the area management table NVTBL and the address management table ADTBL ((d) in FIG. 8). For example, as illustrated in FIG. 13, the allocating unit ALC of the firmware BMCFW allocates, in the area management table NVTBL, an area for the number of banks BIOSBKN representing the number of banks BK3 to BK6 to be newly allocated (that is, “4”). The allocating unit ALC also allocates areas for the bank sizes BK3SZ to BK6SZ respectively representing the sizes of the banks BK3 to BK6 in the area management table NVTBL. The allocating unit ALC further allocates, in the address management table ADTBL, areas for the offset values offsetmin and offsetmax of the banks BK3 to BK6 to be newly allocated.

The firmware BMCFW changes the state BMC-ST from “0” to “1” to indicate that the BMC is performing the process of switching the existing BIOSINF area to the newly allocated BIOSINF area ((e) in FIG. 8). The firmware BMCFW then newly allocates banks BK (for example, BK3 to BK6) corresponding to the new BIOSINF area specified by the firmware BMCFW in the non-volatile memory NVMS ((f) in FIG. 8). That is, when the number of banks BK for retaining the BIOSINF information is changed, the allocating unit ALC adds the banks BK used after the change in the non-volatile memory NVMS. The firmware BMCFW erases data in the newly allocated banks BK. The existing BIOSINF area (that is, banks BK0 and BK1) are maintained instead of being deleted.

For example, in the case where it is detected that the number of banks BK for retaining the new BIOSINF information newly specified by the firmware BMCFW is less than the number of banks BIOSBKN, the requested BIOSINF area is newly allocated in the non-volatile memory NVMS. Note that in the case where the number of banks BK for retaining the BIOSINF information specified by the firmware BMCFW is equal to the number of existing banks BIOSBKN, the process of switching the existing BIOSINF area to the new BIOSINF area is not performed.

FIG. 13 illustrates the state where the banks BK3 to BK6 are newly allocated in the non-volatile memory NVMS of each system board SB and allocation of the banks BK3 to BK6 is reflected in the area management table NVTBL and the address management table ADTBL. In the state illustrated in FIG. 13, information of the banks BK3 to BK6 is added to the area management table NVTBL and the address management table ADTBL and the state BMC-ST is set to “1”, compared with the state illustrated in FIG. 12.

The bank sizes BK3SZ, BK4SZ, BK5SZ, and BK6SZ are an example of second size information respectively representing sizes of the banks BK3, BK4, BK5, and BK6 assigned to the BIOSINF area. In FIG. 13, the address management table ADTBL is an example of an address information retaining portion that retains the offset values offsetmin and offsetmax representing the addresses assigned to the banks BK3 to BK6. The offset values offsetmin and offsetmax of the banks BK3 to BK6 are an example of second address information.

As a result of addition of information regarding the banks BK3 to BK6 to the area management table NVTBL and the address management table ADTBL, the BIOS is able to access both the existing BIOSINF area (old) and the new BIOSINF area (new). That is, the BIOS is able to extract the valid BIOS setting information by executing the variable reclaim process by using the existing BIOSINF information and to store the extracted BIOS setting information in the BIOSINF area newly allocated.

Referring back to FIG. 8, the firmware MMBFW acquires the area management table NVTBL and detects that the firmware BMCFW is performing the BIOSINF area switching process in accordance with the BMC-ST of “1” ((g) in FIG. 8). As a result of provision of an area retaining the state BMC-ST in the area management table NVTBL in this way, the firmware MMBFW is able to detect execution of the BIOSINF area switching process by the firmware BMCFW. Thus, the firmware MMBFW is able to perform the BIOSINF area switching process in cooperation with the firmware BMCFW. Note that the firmware MMBFW acquires the area management table NVTBL on a certain cycle after the management board MMB is rebooted.

In response to detection of the state BMC-ST of “1”, the firmware MMBFW saves the hardware configuration table HWTBL ((h) in FIG. 8) and sets the hardware configuration table HWTBL to a basic configuration ((i) in FIG. 8). The basic configuration refers to a configuration in which each partition PT is assigned a single system board SB and all the system boards SB are set as the home system boards SB. As a result of the change in the hardware configuration table HWTBL, all the system boards SB are assigned as the home system boards SB to the respective partition PT. FIG. 14 illustrates the state of the non-volatile memory NVMM in which the existing hardware configuration table HWTBL is saved and the hardware configuration table HWTBL is set to the basic configuration.

Referring back to FIG. 8, the firmware MMBFW instructs the firmware BMCFW to store the BIOSINF information and the BMCINF information that are retained in the non-volatile memory NVMM in accordance with the hardware configuration table HWTBL that is set to the basic configuration ((j) in FIG. 8). The firmware BMCFW that is instructed to store the BIOSINF information and the BMCINF information is the firmware BMCFW of the home system board SB that is newly assigned to each partition PT (that is, the home system board SB whose configuration has been changed).

In the example illustrated in FIG. 14, since the home system board SB0 is continuously assigned to the partition PT0, the instruction for storing the BIOSINF information and the BMCINF information may be omitted for the firmware BMCFW of the home system board SB0. Since each of the other home system boards SB1 to SB3 are newly assigned to the partitions PT1 to PT3, respectively, the firmware BMCFW of the other home system boards SB1 to SB3 is instructed to store the BIOSINF information and BMCINF information.

The instructed firmware BMCFW erases data in the existing BIOSINF area and the existing BMCINF area in the non-volatile memory NVMS. The firmware BMCFW then stores the BIOSINF information and the BMCINF information that are transferred from the firmware MMBFW in the existing BIOSINF area and the existing BMCINF area from which data has been erased ((k) in FIG. 8). Note that the BIOSINF information and the BMCINF information transferred from the firmware MMBFW are sometimes stored in the system board SB different from the original system board SB. However, since the existing BIOSINF information and the existing BMCINF information used before the unified firmware update are included in any of the system boards SB0 to SB3, the loss of the information is successfully avoided in the entire information processing system SYS2.

The firmware MMBFW instructs the firmware BMCFW to change the state MMB-ST from “0” to “1” ((l) in FIG. 8). The state MMB-ST of “1” indicates that the hardware configuration table HWTBL is set to the basic configuration and the management board MMB is performing the process of switching the existing BIOSINF area to the newly allocated BIOSINF area. In response to the instruction from the firmware MMBFW, the firmware BMCFW changes the state MMB-ST in the area management table NVTBL from “0” to “1” ((m) in FIG. 8).

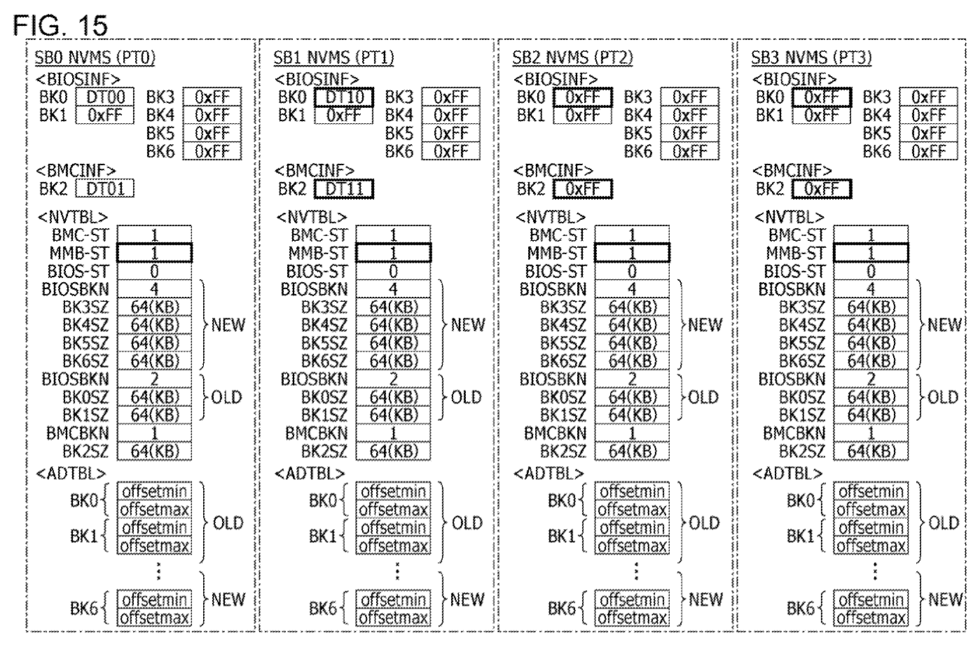

FIG. 15 illustrates the state in which the BIOSINF information and the BMCINF information transferred from the firmware MMBFW are stored in the non-volatile memory NVMS. In the state illustrated in FIG. 15, the BIOSINF information and the BMCINF information of the system board SB1 and the BIOSINF information and the BMCINF information of the system board SB2 are switched and the BIOSINF information and the BMCINF information of the system board SB3 are erased, compared with the state illustrated in FIG. 13. In addition, the state MMB-ST is set to “1”.

As a result of assigning each partition PT a single system board SB in accordance with the hardware configuration table HWTBL having the basic configuration illustrated in FIG. 14, the BIOSINF information and BMCINF information are successfully set in all the system boards SB0 to SB3. Consequently, the invalid data DT30 and the invalid data DT31 (FIG. 13) respectively retained in the BIOSINF area and the BMCINF area of the system board SB3 are successfully deleted.

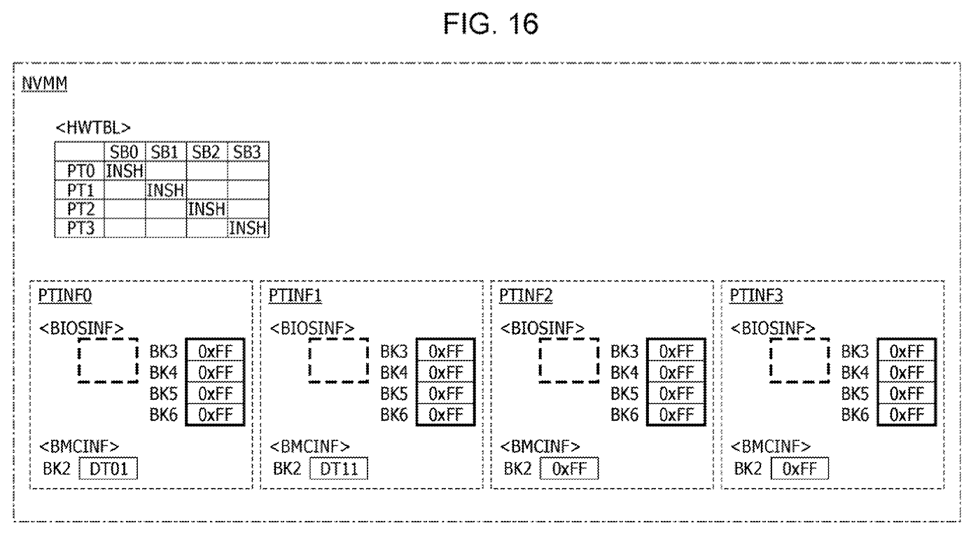

Referring back to FIG. 8, the firmware MMBFW then deletes the existing BIOSINF information (BK0 and BK1) in the PTINF0 area to the PTINF3 area corresponding to the partitions PT0 to PT3 and retained in the non-volatile memory NVMM ((n) in FIG. 8). The firmware MMBFW allocates the banks BK3 to BK6 having the same as the banks BK3 to BK6 allocated in each system board SB, in the BIOSINF area in each of the PTINF0 area to PTINF3 area in accordance with the acquired area management table NVTBL. The firmware MMBFW then initializes data of the allocated banks BK3 to BK6 to “0xFF” ((o) in FIG. 8). FIG. 16 illustrates the state in which the banks BK0 and BK1 are deleted and the banks BK3 to BK6 are allocated in the non-volatile memory NVMM.

Referring next to FIG. 9, the firmware MMBFW reboots the management board MMB and instructs the firmware BMCFW of all the partitions PT0 to PT3 to power on ((a) in FIG. 9). In response to the power-on instruction, the firmware BMCFW powers on the corresponding partition PT ((b) in FIG. 9). In each system board SB, the BMC and the non-volatile memory NVMS are supplied with power all the time. In response to power-on of the partition PT, the CPU starts operating to launch the BIOS, and the BIOS starts the POST ((c) in FIG. 9). The BIOS acquires the area management table NVTBL via the BMC and detects that the management board MMB and the BMC are performing the BIOSINF area switching process in accordance with the state MMB-ST of “1” and the state BMC-ST of “1” ((d) in FIG. 9). As a result of provision of areas retaining the state MMB-ST and the state BMC-ST in the area management table NVTBL, the BIOS is able to detect execution of the BIOSINF area switching process by the firmware MMBFW and the firmware BMCFW. Thus, the BIOS can detect the start timing of the variable reclaim process that is performed in response to the BIOSINF area switching process. That is, the BIOS starts an extraction process (variable reclaim process) for extracting the valid BIOS setting information from the existing banks BK0 and BK1 in accordance with the value “1” retained in the states MMB-ST and BMC-ST.

Since the BIOS has detected that the management board MMB and the BMC are performing the BIOSINF area switching process, the BIOS suspends the POST ((e) in FIG. 9). The BIOS then instructs the firmware BMCFW to change the state BIOS-ST from “0” to “1” to perform the variable reclaim process ((f) in FIG. 9). In response to the instruction from the BIOS, the firmware BMCFW changes the state BIOS-ST of the area management table NVTBL from “0” to “1” ((g) in FIG. 9). As a result of providing the area retaining the state BIOS-ST in the area management table NVTBL, the firmware BMCFW is successfully detects that the variable reclaim process is being performed.

The BIOS leaves the valid BIOS setting information and deletes the invalid BIOS setting information retained in the BIOSINF area of the non-volatile memory NVMS by performing the variable reclaim process ((h) in FIG. 9). Specifically, the BIOS repeatedly performs an operation of extracting valid BIOS setting information from the bank BK0 in which the existing BIOS setting information is stored and an operation of storing the extracted BIOS setting information in the bank BK1. For example, the BIOS performs this process by using the existing variable reclaim function. Note that the BIOS may perform a process of storing the valid BIOS setting information extracted from the bank BK0 directly to the bank BK3 by using a function different from the existing variable reclaim function. In this case, a process of copying the valid BIOS setting information from the existing bank BK0 to the new bank BK3 (described later) is omitted.

For example, when reading the BIOS setting information from the non-volatile memory NVMS, the BIOS specifies the bank BK to be accessed, the offset value of the address, and the read size as parameters of an IPMI command. When writing the BIOS setting information in the non-volatile memory NVMS, the BIOS specifies the bank BK to be accessed, the address offset value, the write size, and data to be written (BIOS setting information) as parameters of an IPMI command.

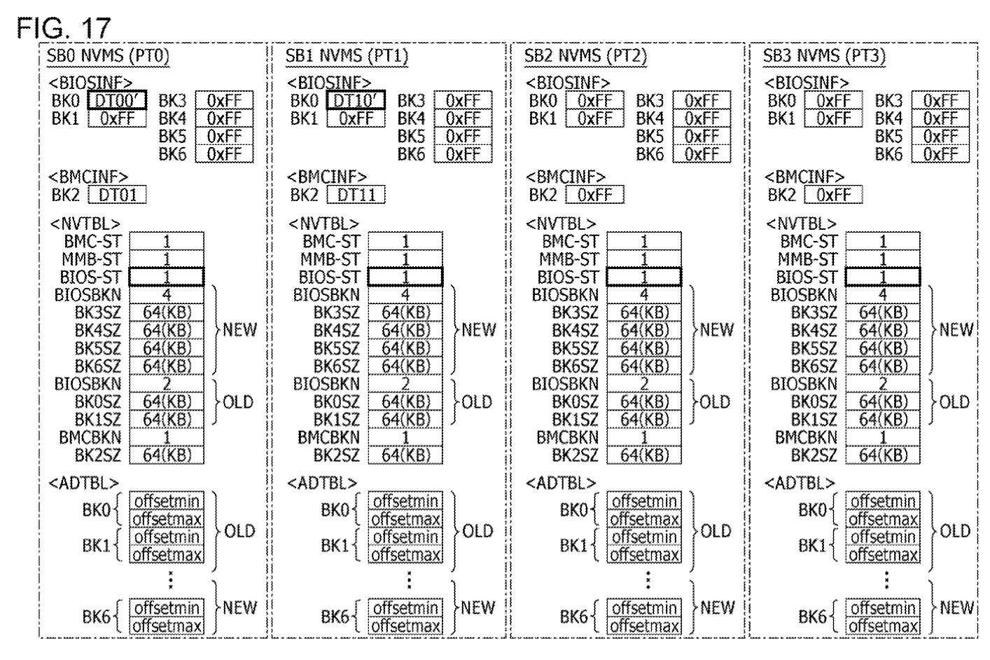

After extracting all the pieces of valid BIOS setting information, the BIOS instructs the firmware BMCFW to erase data in the bank BK0. After the data in the bank BK0 is erased, the BIOS writes the valid BIOS setting information retained in the bank BK1 back to the bank BK0. Note that access to the BIOSINF area of the non-volatile memory NVMS is controlled by the firmware BMCFW in accordance with an instruction from the BIOS. FIG. 17 illustrates the state of the non-volatile memory NVMS for which the variable reclaim process is completed.

Then, the BIOS instructs the firmware BMCFW to change the state BIOS-ST from “1” to “2” ((i) in FIG. 9). In response to the instruction from the BIOS, the firmware BMCFW changes the state BIOS-ST in the area management table NVTBL from “1” to “2” ((j) in FIG. 9). The state BIOS-ST of “2” indicates that the valid BIOS setting information extracted by execution of the variable reclaim process is being copied from the existing BIOSINF area (bank BK0) to the newly allocated BIOSINF area (bank BK3).

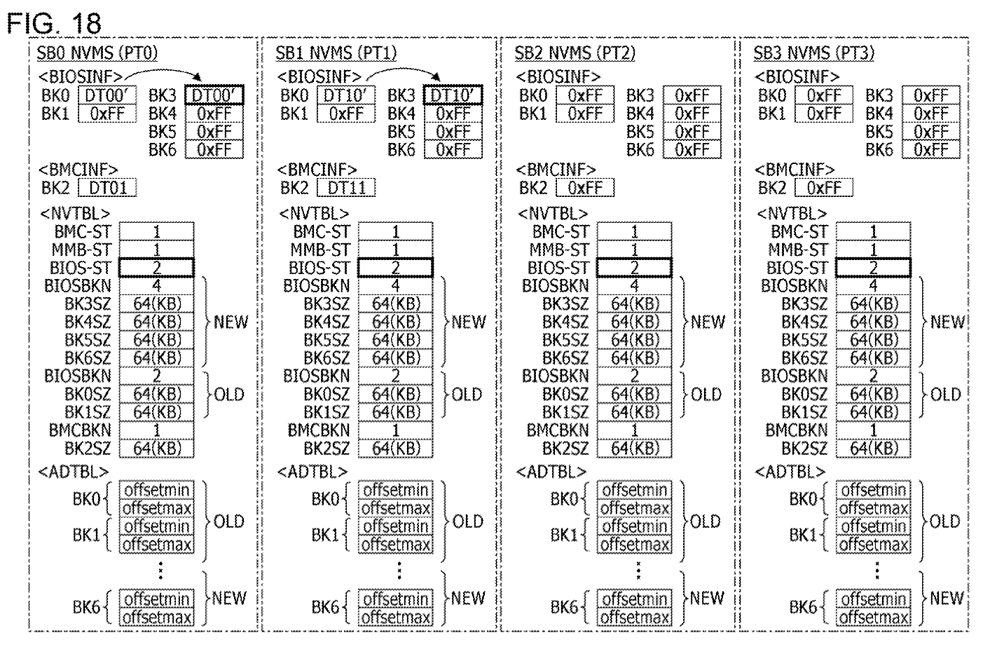

The BIOS repeatedly instructs the firmware BMCFW to copy the valid BIOS setting information from the existing bank BK0 to the newly allocated bank BK3 ((k) in FIG. 9). An instruction for copying the valid BIOS setting information from the existing bank BK0 to the newly allocated bank BK3 is implemented by alternately issuing a read command for the bank BK0 and a write command for the bank BK3. The firmware BMCFW reads copy-target BIOS setting information in response to the read command and stores the valid BIOS setting information contained in the write command in the bank BK3 in response to the write command. The storing unit STR of the firmware BMCFW performs storage of the valid BIOS setting information in the bank BK3 in response to a write command. That is, in response to an instruction from the BIOS, a copy process for copying copy-target BIOS setting information from the bank BK0 to the bank BK3 is performed. FIG. 18 illustrates the state of the non-volatile memory NVMS in which storage of the BIOS setting information from the bank BK0 to the bank BK3 is completed.

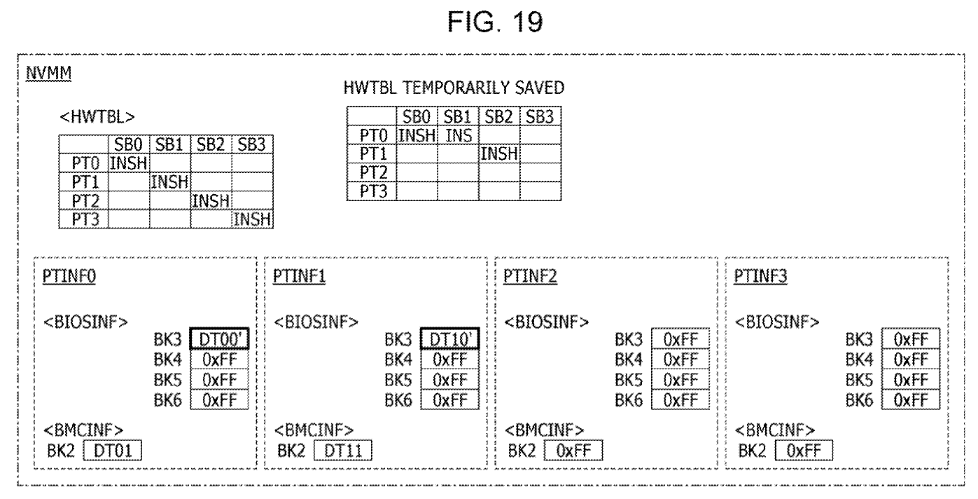

The firmware BMCFW also instructs the firmware MMBFW to store the copied BIOS setting information in the bank BK3 allocated in the PTINF area of the non-volatile memory NVMM ((l) in FIG. 9). As a result of storing “2” in the state BIOS-ST in the area management table NVTBL, the firmware BMCFW is able to determine to transfer to the firmware MMBFW the BIOS setting information transferred from the BIOS together with the write command. The firmware MMBFW stores the BIOS setting information in the bank BK3 allocated in the corresponding PTINF area every time the BIOS setting information is transferred from each firmware BMCFW ((m) in FIG. 9). FIG. 19 illustrates the state of the non-volatile memory NVMM in which the valid BIOS setting information is stored in the new bank BK3 in the PTINF area.

After copying of all the BIOS setting information is finished, the BIOS instructs the firmware BMCFW to change the state BIOS-ST from “2” to “0” ((n) in FIG. 9). In response to the instruction from the BIOS, the firmware BMCFW changes the state BIOS-ST in the area management table NVTBL from “2” to “0” and detects that the BIOS has completed copying the BIOS setting information ((o) in FIG. 9).

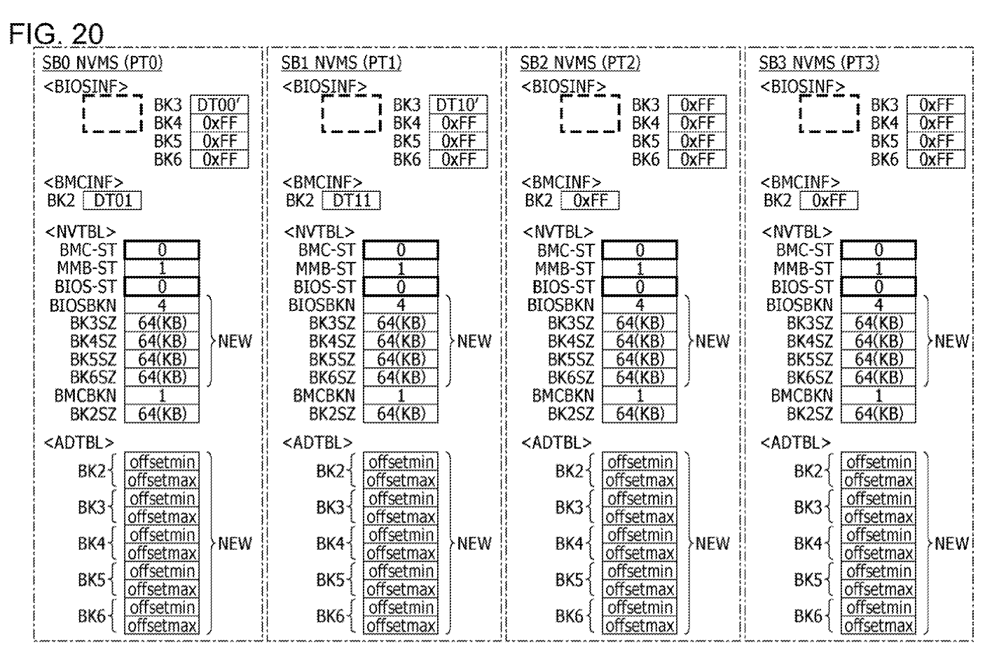

In response to the state BIOS-ST being set to “0”, the firmware BMCFW deletes the existing BIOSINF area (banks BK0 and BK1) used in the variable reclaim process ((p) in FIG. 9). Specifically, the deleting unit DEL of the firmware BMCFW deletes the banks BK0 and BK1 after the valid BIOS setting information is stored in the bank BK3. In addition, the deleting unit DEL of the firmware BMCFW reflects the deletion of the banks BK0 and BK1 in the area management table NVTBL and the address management table ADTBL ((q) in FIG. 9). Specifically, the deleting unit DEL of the firmware BMCFW deletes the bank sizes BK0SZ and BK0SZ respectively representing the existing banks BK0 and BK1 from the area management table NVTBL after the valid BIOS setting information is stored in the bank BK3. In addition, the deleting unit DEL of the firmware BMCFW deletes the offset values offsetmin and offsetmax of the existing banks BK0 and BK1 from the address management table ADTBL. Since the BIOSINF area switching process completes here, the firmware MMBFW changes the state BMC-ST from “1” to “0” ((r) in FIG. 9). FIG. 20 illustrates the state of the non-volatile memory NVMS in which the area management table NVTBL and the address management table ADTBL are updated in accordance with the deletion of the banks BK0 and BK1 after the BIOS setting information is stored in the bank BK3.

Referring next to FIG. 10, the firmware MMBFW acquires the area management table NVTBL from the BMC ((a) in FIG. 10) and detects completion of the BIOSINF area switching process in accordance with the state BMC-ST of “0” ((b) in FIG. 10). Then, the firmware MMBFW instructs the firmware BMCFW to power off all the partitions PT0 to PT3 (SB0 to SB3) ((c) in FIG. 10). The firmware BMCFW stops supplying power to the corresponding partition PT (that is, the corresponding system board SB) and ends the BIOS ((d) in FIG. 10). Note that power supply to the BMC and the non-volatile memory NVMS is continued in each system board SB.

Then, the firmware MMBFW instructs the firmware BMCFW to change the state MMB-ST from “1” to “0” since the BIOSINF area switching process based on the hardware configuration table HWTBL set to the basic configuration is completed ((e) in FIG. 10). In response to the instruction from the firmware MMBFW, the firmware BMCFW changes the state MMB-ST in the area management table NVTBL from “1” to “0” ((f) in FIG. 10).

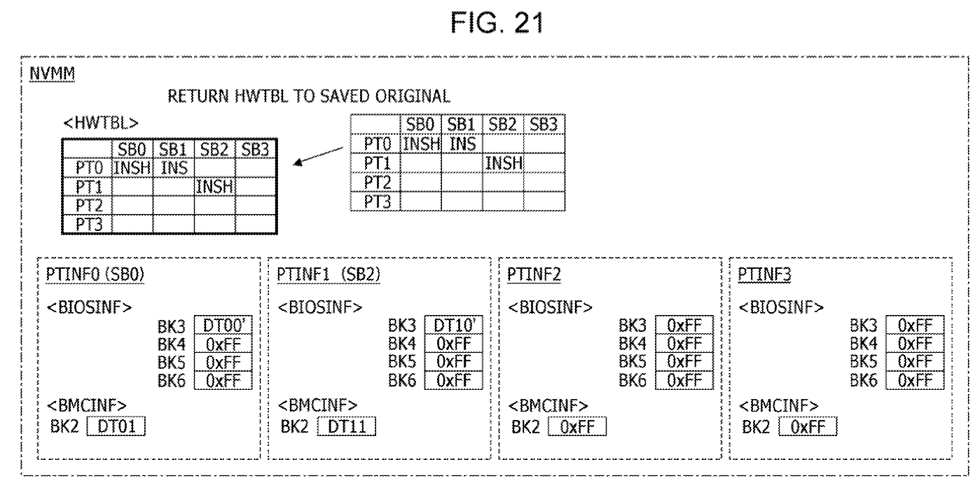

Then, the firmware MMBFW returns the hardware configuration table HWTBL to the saved configuration ((g) in FIG. 10). As a result of the change in the hardware configuration table HWTBL, the configuration of the partitions PT of the information processing system SYS2 returns to the original configuration set before the unified firmware update. FIG. 21 illustrates the state of the non-volatile memory NVMM in which the hardware configuration table HWTBL is returned to the save configuration. In other words, FIG. 21 illustrates the state of the non-volatile memory NVMM of the management board MMB after a BIOSINF area extension process is completed.

The firmware MMBFW instructs the firmware BMCFW of the home system board SB of each partition PT to store the BIOSINF information and the BMCINF information retained in the non-volatile memory NVMM ((h) in FIG. 10). The firmware BMCFW of the home system board SB that has received the instruction stores the BIOSINF information and the BMCINF information transferred from the firmware MMBFW in the BIOSINF area and the BMCINF area, respectively ((i) in FIG. 10).

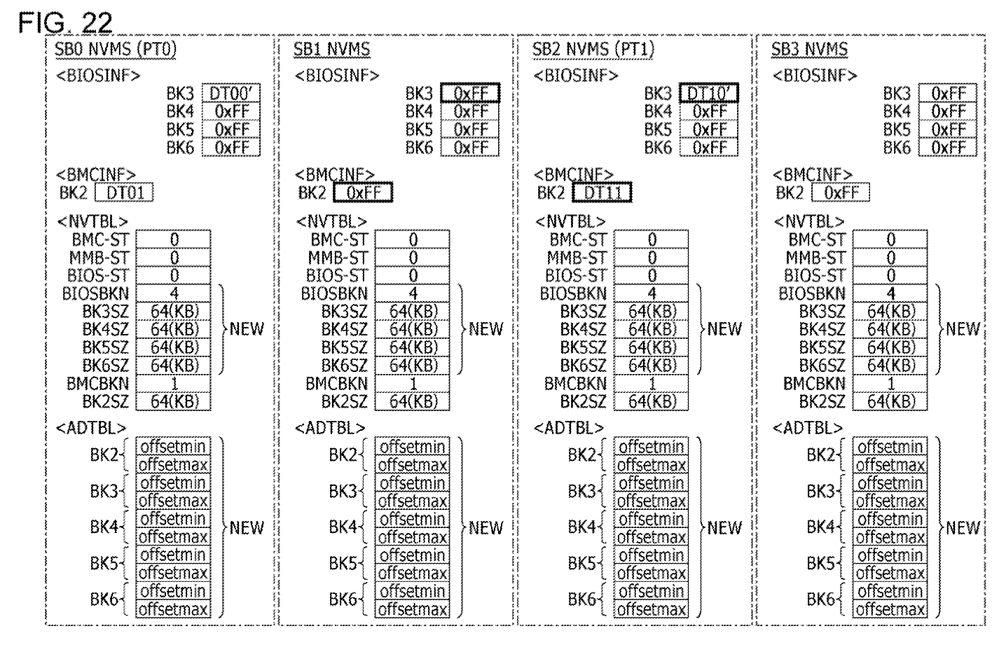

In this way, the BIOSINF area extension process is completed in all the system boards SB. FIG. 22 illustrates the state of the non-volatile memory NVMS of each system board SB after the completion of the BIOSINF area extension process. In FIG. 22, the number of banks BK is increased and the home system boards SB0 and SB2 respectively assigned to the partitions PT0 and PT1 retain valid BIOS setting information DT00′ and valid BIOS setting information DT10′, compared with FIG. 12 illustrating the state before the BIOSINF area extension process is started. Thereafter, the partitions PT0 and PT1 use the new BIOSINF areas to which the valid BIOS setting information DT00′ and the valid BIOS setting information DT10′ are copied as the existing BIOSINF areas, respectively.

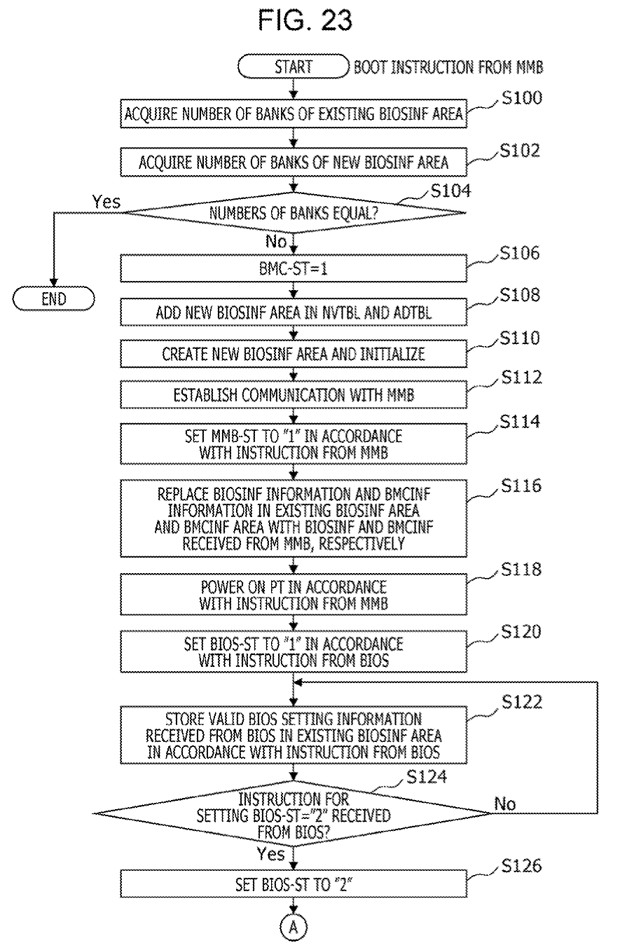

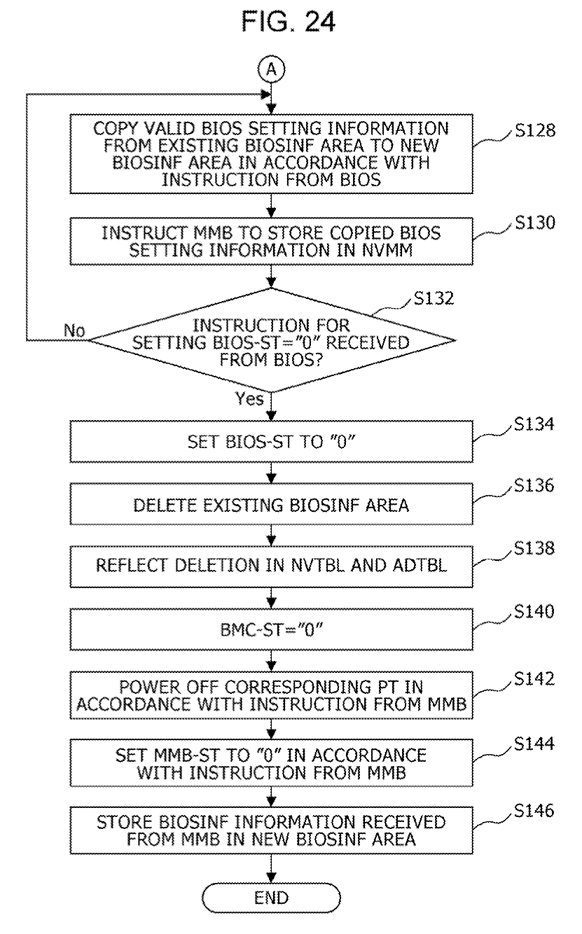

FIGS. 23 and 24 illustrate an example of a process performed by the BMC in the information processing system SYS2 illustrated in FIG. 3. FIG. 24 illustrates the process that follows the process illustrated in FIG. 23. The process illustrated in FIGS. 23 and 24 starts in response to the firmware BMCFW of the BMC boots the BMC in response to a BMC boot instruction from the management board MMB. That is, FIGS. 23 and 24 illustrate an example of a control method and a control program for the information processing system SYS2. A detailed description of processing that is substantially the same as the processing illustrated in FIGS. 8 to 10 is omitted.

In step S100, the BMC first acquires the number of banks BIOSBKN of the existing BIOSINF area retained in the area management table NVTBL. In step S102, the BMC acquires the number of banks of the new BIOSINF area written in the firmware BMCFW. In step S104, the BMC determines whether the number of banks acquired in step S100 is equal to the number of banks acquired in step S102. If the numbers of banks are equal, the BMC ends the process because the existing BIOSINF area is continuously used. If the numbers of banks are different from each other, the process proceeds to step S106 to switch the existing BIOSINF area to the new BIOSINF area.

In step S106, the BMC changes the state BMC-ST from “0” to “1”. In step S108, the BMC adds information representing the BIOSINF area to be newly allocated to the area management table NVTBL and the address management table ADTBL. Then in step S110, the BMC newly allocates, in the non-volatile memory NVMS, the number of banks BK corresponding to the new BIOSINF area.

In step S112, the BMC establishes communication with the management board MMB. In step S114, the BMC changes the state MMB-ST in the area management table NVTBL from “0” to “1” in response to an instruction from the management board MMB. In step S116, upon receiving the BIOSINF information and the BMCINF information from the management board MMB, the BMC stores the received BIOSINF information and BMCINF information in the existing BIOSINF area and the BMCINF area, respectively. That is, the BIOSINF information retained in the existing BIOSINF area and the BMCINF information retained in the existing BMCINF area are respectively replaced with the BIOSINF information and the BMCINF information received from the management board MMB.

In step S118, the BMC powers on the partition PT in response to an instruction from the management board MMB. In response to power-on of the partition PT, the BIOS is launched. In step S120, in response to an instruction from the BIOS, the BMC sets the state BIOS-ST in the area management table NVTBL to “1”, which indicates that the variable reclaim process is being performed. In step S122, the BMC stores valid BIOS setting information extracted through the variable reclaim process performed by the BIOS in the existing BIOSINF area from which data has been erased. In step S124, the BMC determines whether an instruction for setting the state BIOS-ST in the area management table NVTBL to “2” is received. If the instruction for setting the state BIOS-ST to “2” is received, it is determined that the variable reclaim process is finished, and the process proceeds to step S126. If the instruction for setting the state BIOS-ST to “2” is not received, it is determined that the variable reclaim process is being performed, and the process returns to step S122. In step S126, the BMC sets the state BIOS-ST in the area management table NVTBL to “2”, which indicates that the valid BIOS setting information is being copied to the new BIOSINF area.

In step S128 illustrated in FIG. 24, the BMC copies the valid BIOS setting information from the existing BIOSINF area to the new BIOSINF area in response to an instruction from the BIOS. In step S130, the BMC instructs the management board MMB to store the copied BIOS setting information in the non-volatile memory NVMM. In step S132, the BMC determines whether an instruction for setting the state BIOS-ST in the area management table NVTBL to “0” is received. If the instruction for setting the state BIOS-ST to “0” is received, it is determined that copying of the valid BIOS setting information is finished and the process proceeds to step S134. If the instruction for setting the state BIOS-ST to “0” is not received, it is determined that copying of the valid BIOS setting information is not finished and the process returns to step S128.

In step S134, the BMC sets the state BIOS-ST in the area management table NVTBL to “0”. In step S136, the BMC deletes the existing BIOSINF area used in the variable reclaim process. In step S138, BMC reflects the deletion of the existing BIOSINF area in the area management table NVTBL and the address management table ADTBL. In step S140, the BMC changes the state BMC-ST from “1” to “0”.

In step S142, the BMC powers off a corresponding one of the partitions PT0 to PT3 in response to a power-off instruction from the management board MMB. In step S144, the BMC changes the state MMB-ST in the area management table NVTBL from “1” to “0” in response to an instruction from the management board MMB. In step S146, the BMC stores the BIOSINF information received from the management board MMB in the new BIOSINF area and ends the BIOSINF area switching process. Then, the BMC performs a process for managing operations of the CPU or the like mounted on the system board SB.

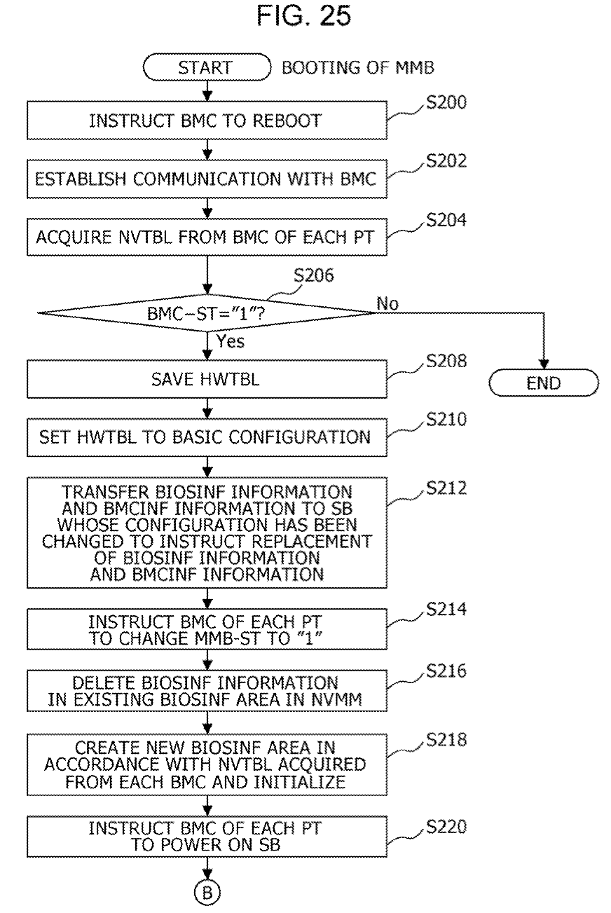

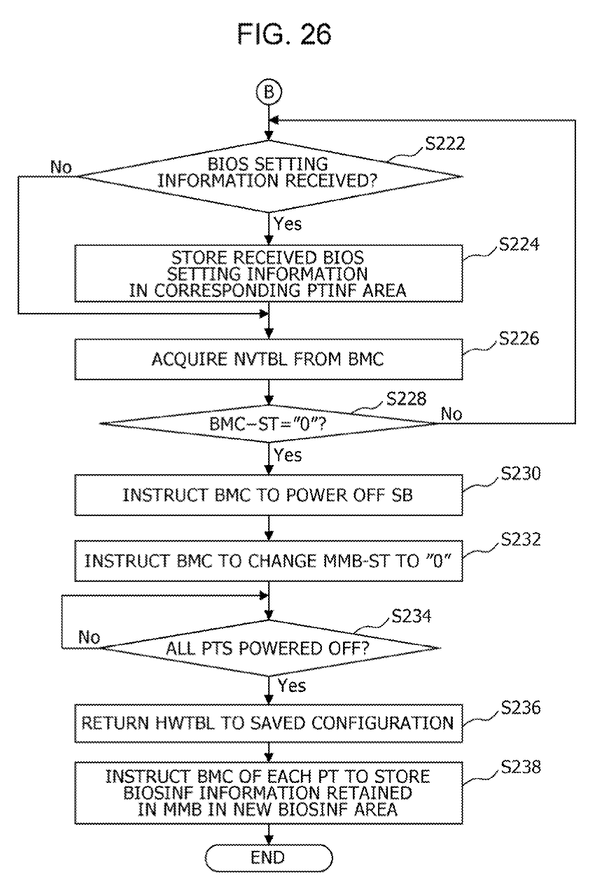

FIGS. 25 and 26 illustrate an example of a process performed by the management board MMB in the information processing system SYS2 illustrated in FIG. 3. FIG. 26 illustrates the process that follows the process illustrated in FIG. 25. The process illustrated in FIG. 25 starts in response to booting of the management board MMB. FIGS. 25 and 26 illustrate an example of a control method and a control program of the information processing system SYS2. A detailed description of processing that is substantially the same as the processing illustrated in FIGS. 8 to 10 is omitted.

In step S200, the management board MMB instructs the BMC of each system board SB to reboot. In step S202, the management board MMB establishes communication with each system board SB. In step S204, the management board MMB acquires the area management table NVTBL from the BMC of each partition PT.

In step S206, the management board MMB determines whether the state BMC-ST in the area management table NVTBL acquired from the BMC of each partition PT is “1”. If the state BMC-ST is “1”, the process proceeds to step S208 to perform the BIOSINF area switching process. If the state BMC-ST is not “1”, the process ends since the BIOSINF area switching process is not performed. In step S208, the management board MMB saves the hardware configuration table HWTBL if the state BMC-ST is “1” for all the system boards SB. In step S210, the management board MMB sets the hardware configuration table HWTBL to the basic configuration as illustrated using a thick frame in FIG. 14.

In step S212, the management board MMB transfers, to each home system board SB whose configuration has been changed, the BIOSINF information and the BMCINF information retained in the non-volatile memory NVMM to instruct the home system board SB to replace the BIOSINF information and the BMCINF information. Processing of step S212 and the following steps is performed for each partition PT. In step S214, the management board MMB instructs the BMC to change the state MMB-ST in the area management table NVTBL from “0” to “1”. In step S216, the management board MMB deletes the existing BIOSINF information in the PTINF0 area to the PTINF3 area respectively corresponding to the partitions PT0 to PT3 and retained in the non-volatile memory NVMM.

In step S218, the management board MMB creates a new BIOSINF area in each of the PTINF0 area to the PTINF3 area in accordance with the area management table NVTBL acquired in step S204. The management board MMB then initializes data in the created new BIOSINF area to “0xFF”. In step S220, the management board MMB instructs the BMC to power on the partition PT.

In step S222 illustrated in FIG. 26, the management board MMB determines whether valid BIOS setting information extracted through the variable reclaim process is received from the BMC. If the valid BIOS setting information is received, the process proceeds to step S224. If the valid BIOS setting information is not received, the process proceeds to step S226. In step S224, the management board MMB stores the valid BIOS setting information received from each BMC in the new BIOSINF area of the PTINF area corresponding to the partition PT to which the BMC belongs. That is, valid BIOS setting information stored in the non-volatile memories NVMS of the respective system boards SB are backed up in the non-volatile memory NVMM of the management board MMB.

In step S226, the management board MMB acquires the area management table NVTBL from each BMC. In step S228, the management board MMB determines whether the state BMC-ST in the area management table NVTBL acquired from each BMC is “0”. If the state BMC-ST is “0”, it is determined that the BMC has completed the BIOSINF area switching process and the process proceeds to step S230. If the state BMC-ST is not “0”, it is determined that the BMC is performing the BIOSINF area switching process and the process returns to step S222.

In step S230, the management board MMB instructs each BMC to power off the corresponding partition PT. In step S232, the management board MMB instructs each BMC to change the state MMB-ST from “1” to “0”. In step S234, the management board MMB determines whether all the partitions PT (that is, all the system boards SB) are powered off. If all the partitions PT are powered off, the process proceeds to step S236. If there is a partition PT that is not powered off, the determination of step S234 is repeated.

In step S236, the management board MMB returns the hardware configuration table HWTBL to the saved configuration. In step S238, the management board MMB instructs the BMC of the home system board SB of each partition PT to store the BIOSINF information retained in the non-volatile memory NVMM in the new BIOSINF area. The management board MMB also instructs the BMC of the home system board SB of each partition PT to store the BMCINF information retained in the non-volatile memory NVMM in the BMCINF area. If the processing up to step S238 is completed for all the partitions PT, the management boards MMB ends the BIOSINF area switching process. Then, the management board MMB performs a process of managing the entire information processing system SYS2.

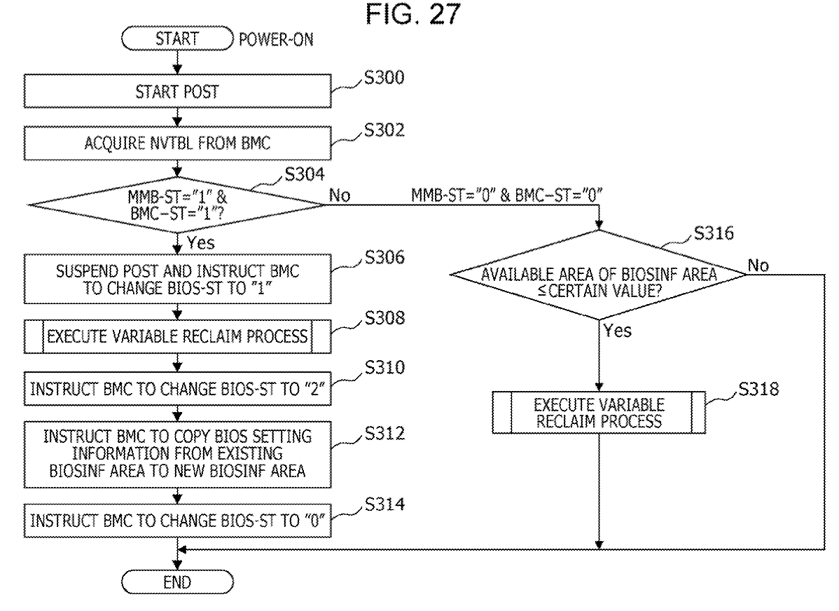

FIG. 27 illustrates an example of a process performed by the BIOS in the information processing system SYS2 illustrated in FIG. 3. The process illustrated in FIG. 27 starts in response to the firmware BMCFW of the BMC powering on the partition PT. A detailed description of processing that is substantially the same as the processing illustrated in FIGS. 8 to 10 is omitted.

In step S300, the BIOS starts the POST. In step S302, the BIOS acquires the area management table NVTBL from the BMC. In step S304, the BIOS determines whether both the states MMB-ST and BMC-ST are “1” in the area management table acquired from the BMC of the corresponding partition PT. If both the states MMB-ST and BMC-ST are “1”, the process proceeds to step S306. If both the states MMB-ST and BMC-ST are “0”, the process proceeds to step S316.

In the normal operating state, the states MMB-ST and BMC-ST do not take different logical values. Thus, if the BIOS detects that the logical values of the states MMB-ST and BMC-ST are different from each other, the BIOS sends an error notation to the BMC. The BMC that has received the error notification aborts the following BIOSINF area switching process and notifies the management board MMB of abortion of the BIOSINF area switching process. The management board MMB that is notified of abortion of the BIOSINF area switching process, for example, instructs the BMC to power off the partition PT and restarts the process illustrated at the first part of FIG. 9. As described above, in the normal operating state, the states MMB-ST and BMC-ST do not take different logical values. Thus, the BIOS may detect only the state BMC-ST, and the process may proceed to step S306 if the state BMC-ST is “1” and to step S316 if the state BMC-ST is “0”.

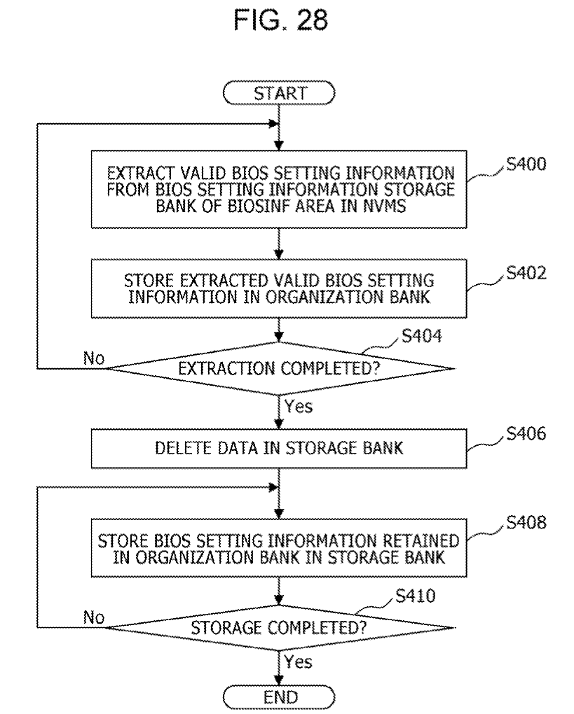

In step S306, the BIOS suspends the POST to perform the variable reclaim process of the BIOSINF area switching process and instructs the BMC to change the state BIOS-ST in the area management table NVTBL from “0” to “1”. In step S308, the BIOS performs the variable reclaim process. FIG. 28 illustrates an example of the variable reclaim process.

In step S310, the BIOS instructs the BMC to change the state BIOS-ST in the area management table NVTBL from “1” to “2” to copy the BIOS setting information from the existing BIOSINF area to the new BIOSINF area. In step S312, the BIOS instructs the BMC to copy the BIOS setting information from the existing BIOSINF area to the new BIOSINF area. In step S314, the BIOS instructs the BMC to change the state BIOS-ST in the area management table NVTBL from “2” to “0” after completing copying of the BIOS setting information. Then, the BIOS is stopped in response to power-off of the partition PT in step S142 illustrated in FIG. 24.

If the BIOSINF area switching process is not performed, the BIOS determines whether an available area in the BIOSINF area is less than or equal to a certain value in step S316. If the available area in the BIOSINF area is less than or equal to the certain value, the process proceeds to step S318. If the available area in the BIOSINF area is greater than the certain value, the process ends. In step S318, the BIOS performs the variable reclaim process and ends the process. Then, the BIOS performs other processing that is performed when the BIOS is launched.

FIG. 28 illustrates an example of the variable reclaim process illustrated in FIG. 27. The process illustrated in FIG. 28 is performed by the BIOS.

In step S400, the BIOS extracts valid BIOS setting information from the storage bank BK for storing the BIOS setting information in the BIOSINF area in the non-volatile memory NVMS. For example, the storage bank BK is the bank BK0 illustrated in FIG. 4. In step S402, the BIOS stores the extracted valid BIOS setting information in an organization bank BK. For example, the organization bank BK is the bank BK1 illustrated in FIG. 4. In step S404, the BIOS determines whether extraction of the valid BIOS setting information is completed. If extraction of the valid BIOS setting information is completed, the process proceeds to step S406. If extraction of the valid BIOS setting information is not completed, the process returns to step S400.

In step S406, the BIOS erases data in the storage bank BK. In step S408, the BIOS stores in the storage bank BK the valid BIOS setting information stored in the organization bank BK. In step S410, the BIOS determines whether storage of the valid BIOS setting information in the storage bank BK is completed. If storage of the valid BIOS setting information in the storage bank BK is completed, the process ends. If storage of the valid BIOS setting information in the storage bank BK is not completed, the process returns to step S408.

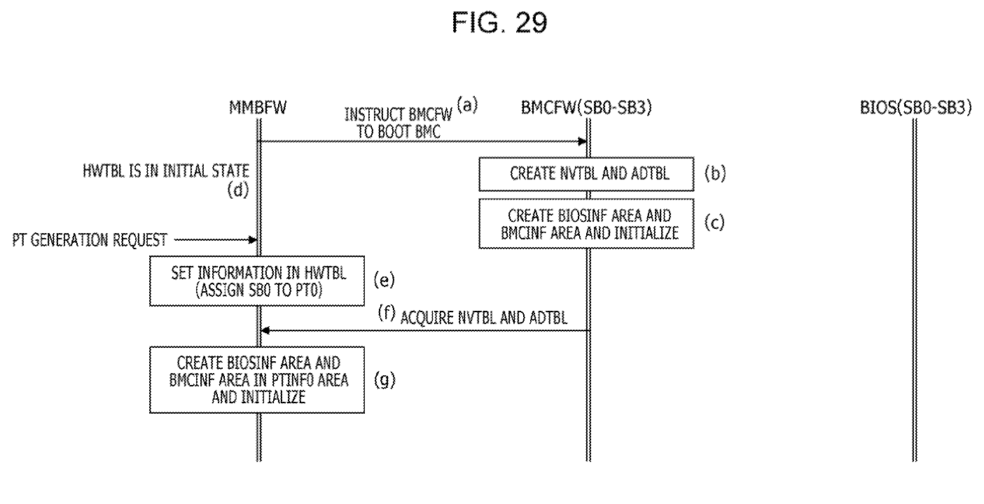

FIG. 29 illustrates an example of an initial operation of the information processing system SYS2 illustrated in FIG. 3. The initial operation is performed in an assembly process at a manufacturer of the information processing system SYS2 or is performed after a factory default process in which the state of the information processing system SYS2 is returned to the pre-shipment state.

In response to power-on of the information processing system SYS2, the firmware MMBFW instructs the firmware BMCFW executed by the BMC of each system board SB to boot ((a) in FIG. 29). In response to the booting instruction, the firmware BMCFW refers to the area management table NVTBL and compares the number of existing banks BIOSBKN with the number of banks NK for newly retaining the BIOSINF information requested by the firmware BMCFW. Since the area management table NVTBL is not present in the initial operation, the firmware BMCFW creates the area management table NVTBL and the address management table ADTBL in accordance with the specifications of the banks BK written in the firmware BMCFW ((b) in FIG. 29. Then, the firmware BMCFW creates the BIOSINF area and the BMCINF area in accordance with the area management table NVTBL and initializes the BIOSINF area and the BMCINF area with “0xFF” ((c) in FIG. 29).

The hardware configuration table HWTBL retained in the non-volatile memory NVMM of the management board MMB is in the state at the time of shipment illustrated in FIG. 5 ((d) in FIG. 29). The firmware MMBFW sets information in the hardware configuration table HWTBL in response to a partition PT generation request from the outside ((e) in FIG. 29). For example, the firmware MMBFW assigns the system board SB0 to the partition PT0.

The firmware MMBFW acquires the area management table NVTBL and the address management table ADTBL from the home system board SB0 of the partition PT0 ((f) in FIG. 29). The firmware MMBFW creates the BIOSINF area and the BMCINF area in the PTINF0 area in the non-volatile memory NVMM in accordance with the information acquired from the partition PT0 and initializes the BIOSINF area and the BMCINF area with “0xFF” ((g) in FIG. 29). Then, the information processing system SYS2 is powered off, and the initial operation of the information processing system SYS2 is completed.

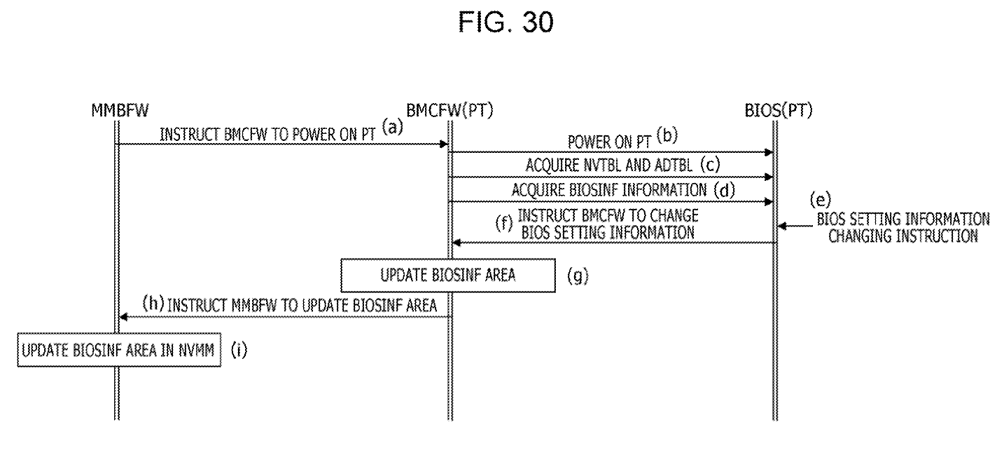

FIG. 30 illustrates an example of an operation performed in the information processing system SYS2 illustrated in FIG. 3 when the partition PT is powered on. First, the firmware MMBFW instructs a certain partition PT to power on ((a) in FIG. 30). The firmware BMCFW of the partition PT instructed to power on powers on the partition PT and the BIOS is launched ((b) in FIG. 30).

The BIOS acquires the area management table NVTBL and the address management table ADTBL from the non-volatile memory NVMS via the firmware BMCFW ((c) in FIG. 30). The BIOS then accesses the BIOSINF area in the non-volatile memory NVMS and acquires the BIOSINF information in accordance with the area management table NVTBL and the address management table ADTBL ((d) in FIG. 30).

In the example illustrated in FIG. 30, an instruction for changing the BIOS setting information is received from the outside while the BIOS is running ((e) in FIG. 30), and the BIOS instructs the firmware BMCFW to change the BIOS setting information ((f) in FIG. 30). The firmware BMCFW updates the BIOSINF area in response to the instruction from the BIOS ((g) in FIG. 30). The firmware BMCFW further instructs the firmware MMBFW to update the BIOSINF area in the non-volatile memory NVMM of the management board MMB ((h) in FIG. 30). In response to the instruction from the firmware BMCFW, the firmware MMBFW updates the BIOSINF area in the non-volatile memory NVMM ((i) in FIG. 30). In this way, the BIOSINF information in the system board SB matches the BIOSINF information in the management board MMB.

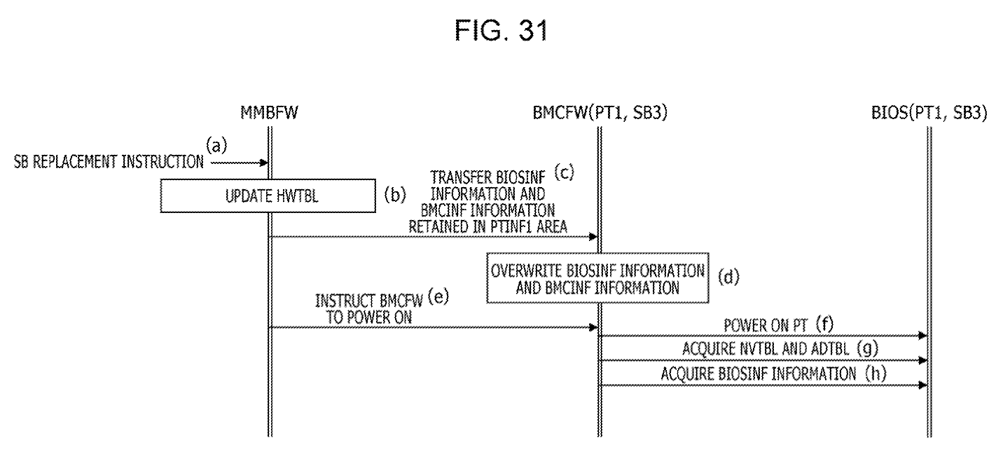

FIG. 31 is an example of an operation performed in the information processing system SYS2 illustrated in FIG. 3 when the system board SB is replaced. An example is described below in which the system board SB2 of the partition PT1 fails and is replaced with the system board SB3 in the case of the configuration of the partitions PT illustrated in the hardware configuration table HWTBL illustrated in FIG. 5.

First, in response to an instruction for replacing the system board SB from the outside ((a) in FIG. 31), the firmware MMBFW updates the hardware configuration table HWTBL and changes the home system board SB from the system board SB2 to the system board SB3 ((b) in FIG. 31). The firmware MMBFW then transfers the BIOSINF information and the BMCINF information retained in the PTINF1 area corresponding to the partition PT1 in the non-volatile memory NVMM to the firmware BMCFW of the system board SB3 ((c) in FIG. 31).

The firmware BMCFW of the system board SB3 rewrites the BIOSINF area of the non-volatile memory NVMS using the transferred BIOSINF information and rewrites the BMCINF area in the non-volatile memory NVMS using the transferred BMCINF information ((d) in FIG. 31).

After the non-volatile memory NVMS is rewritten, the firmware MMBFW instructs the firmware BMCFW of the system board SB3 of the partition PT1 to power on ((e) in FIG. 31). In response to the power-on instruction, the firmware BMCFW of the system board SB3 powers on the partition PT1 and the BIOS is launched ((f) in FIG. 31).

The BIOS acquires the area management table NVTBL and the address management table ADTBL from the non-volatile memory NVMS via the firmware BMCFW ((g) in FIG. 31). The BIOS then accesses the BIOSINF area and acquires the BIOSINF information in accordance with the area management table NVTBL and the address management table ADTBL ((h) in FIG. 31). In this way, the BIOSINF information and the BMCINF information that have been used in the system board SB2 before the failure are continuously used in the system board SB3.

As described above, advantageous effects similar to those of the embodiment illustrated in FIGS. 1 and 2 may be obtained also in the embodiment illustrated in FIGS. 3 to 31. For example, the size of the BIOSINF areas of all the system boards SB are successfully changed without returning the state of the information processing system SYS2 to the pre-shipment state (factory default state). That is, the size of the BIOSINF area that retains setting information of the electronic parts EP of the system boards SB is successfully changed, without losing information set in the corresponding partitions PT (system boards SB). Since the size of the BIOSINF area is successfully changed without human intervention, the time and effort for restoring the lost information may be omitted and human error relating to the settings may be avoided. By reflecting the BIOSINF area having a changed size in the PTINF area in the non-volatile memory NVMM of the management board MMB, the BIOS setting information that is to be changed by the BIOS later is successfully backed up in the PTINF area.

Further, the following advantageous effects may be obtained in the embodiment illustrated in FIGS. 3 to 31. When the size of the BIOSINF area is changed, the BIOS is able to access both the existing BIOSINF area and the new BIOSINF area. Thus, the BIOS is able to perform the variable reclaim process by using the existing BIOSINF information to extract the valid BIOS setting information and is able to store the extracted BIOS setting information in the newly allocated BIOSINF area.

As a result of provision of an area retaining the state BMC-ST in the area management table NVTBL, the firmware MMBFW is able to detect that the firmware BMCFW is performing the BIOSINF area switching process. Thus, the firmware MMBFW is able to perform the BIOSINF area switching process in cooperation with the firmware BMCFW. In addition, as a result of provision of the area retaining the state BMC-ST in the area management table NVTBL, the BIOS is able to detect that the firmware BMCFW is performing the BIOSINF area switching process. Thus, the BIOS can detect the start timing of the variable reclaim process that is performed in response to the BIOSINF area switching process.

By retaining the state BIOS-ST of “1” in the area management table NVTBL while the variable reclaim process is being performed, the firmware BMCFW is able to detect that the BIOS is performing the variable reclaim process. In addition, by retaining the state BIOS-ST of “2” in the area management table NVTBL while the BIOS setting information is being copied, the firmware BMCFW is able to transfer, to the firmware MMBFW, the BIOS setting information transferred from the BIOS for copying.

By assigning each partition PT a single system board SB in accordance with the hardware configuration table HWTBL of the basic configuration, the BIOSINF information and the BMCINF information are successfully set in all the system boards SB. Consequently, for example, the invalid data DT30 and the invalid data DT31 (FIG. 13) respectively retained in the BIOSINF area and the BMCINF area of the system board SB3 are successfully deleted.

Features and advantages of the embodiments will become apparent from the detailed description above. This intends that the appended claims cover the features and advantages of the embodiments described above in a range not departing from the spirit and the scope. The person having ordinary skill in the art could have easily conceived any improvements and changes. Therefore, the scope of the inventive embodiments is not intended to be limited to the description above, and suitable modifications and equivalents included in the scope disclosed by the embodiments may be resorted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a plurality of electronic parts including an arithmetic processor;
a memory; and
a control processor that controls operations of the plurality of electronic parts, the control processor is coupled to the memory and configured to execute a process, the process including;
detecting that a size of a first area, allocated in the memory and retaining setting information of the plurality of electronic parts, is different from a size of a setting information area that is newly specified in response to a change in a function of the information processing apparatus,
allocating, in response to detection by the detecting, a second area that is to retain the setting information in place of the first area in the memory, the second area serving as the setting information area,
storing, in the second area, valid setting information extracted from the first area, and
deleting the first area from the memory after the valid setting information is stored in the second area.

2. The information processing apparatus according to claim 1, wherein in the allocating, in response to the detection by the detecting, second size information representing a size of the second area is added to a size information retaining area that retains first size information representing the size of the first area, and
wherein in the deleting, the first size information retained in the size information retaining area is deleted after the valid setting information is stored in the second area.

3. The information processing apparatus according to claim 1, wherein the arithmetic processor extracts the valid setting information from the first area in response to the detection by the detecting of the control processor, rewrites the first area with the extracted valid setting information, and then causes the control processor to perform the storing, in the second area, the valid setting information with which the first area has been rewritten.

4. The information processing apparatus according to claim 3, wherein the process further including;
setting, in a first state retaining area, a switching state flag indicating that an area retaining the valid setting information is being switched from the first area to the second area, and
wherein the arithmetic processor starts, in response to retaining of the switching state flag in the first state retaining area, an extraction process of extracting the valid setting information from the first area.

5. The information processing apparatus according to claim 1, wherein the memory includes a second state retaining area that retains a state flag indicating one of an extracting state indicating that the valid setting information is being extracted by the arithmetic processor, a copying state indicating that the valid setting information with which the first area has been rewritten is being copied to the second area by the arithmetic processor, and an idle state that is neither the extracting state nor the copying state, and
wherein in the deleting, the first area is deleted in response to a change of the state flag from the copying state to the idle state.

6. The information processing apparatus according to claim 1, wherein the memory includes a plurality of memory elements in each of which a first logical value changes to a second logical value as a result of a writing operation, and
wherein in a case where original setting information retained in the first area or the second area is changed to new setting information, the arithmetic processor writes the new setting information in an area in which no setting information is written and sets the first area or second area retaining the original setting information to an invalid state.

7. An information processing system comprising:
a plurality of information processing apparatuses each including
a plurality of electronic parts including an arithmetic processor,
a memory, and
a control processor, coupled to the memory, that controls operations of the plurality of electronic parts, and
a management apparatus that manages the plurality of information processing apparatuses,
wherein the control processor of each of the plurality of information processing apparatuses is configured to execute a process, the process including;
detecting that a size of a first area, allocated in the memory device and retaining setting information of the plurality of electronic parts, is different from a size of a setting information area that is newly specified in response to a change in a function of the information processing apparatus,
allocating, in response to detection by the detecting, a second area that is to retain the setting information in place of the first area in the memory, the second area serving as the setting information area,
storing, in the second area, valid setting information extracted from the first area, and
deleting the first area from the memory device after the valid setting information is stored in the second area.

8. The information processing system according to claim 7, wherein the management apparatus includes;
a management memory including;
a configuration information retaining area that retains configuration information indicating an information processing apparatus, among the plurality of information processing apparatuses, assigned to a partition that is a unit in which information processing is performed, and
a copy retaining area that is provided for the partition and retains a copy of the setting information retained in the first area in the partition, and
a management processor, coupled to the management memory, and configured to execute a management process including;
allocating, in response to addition of the second area in the partition, a corresponding area for the second area in the copy retaining area, and
storing, in the corresponding area, the valid setting information stored in the second area.

9. The information processing system according to claim 7, wherein the management apparatus includes;
a management memory including;
a configuration information retaining area that retains configuration information indicating an information processing apparatus, among the plurality of information processing apparatuses, assigned to a partition that is a unit in which information processing is performed, and
a copy retaining area that is provided for the partition and retains a copy of the setting information retained in the first area in the partition, and
a management processor coupled to the management memory and configured to execute a management process including;
saving, in response to addition of the second area in the partition, the configuration information retained in the configuration information retaining area and storing, in the configuration information retaining area, configuration information that assigns the plurality of information processing apparatuses to different partitions,
rewriting the first area in each of the plurality of information processing apparatuses with the copy of the setting information retained in the copy retaining area corresponding to the partition to which the information processing apparatus is assigned,
allocating, in the copy retaining area, a corresponding area for the second area,
storing, in the corresponding area, the valid setting information stored in the second area,
returning the saved configuration information to the configuration information retaining area after the valid setting information is stored in the corresponding area, and
storing the valid setting information retained in the corresponding area in the second area of the corresponding partition.

10. A method for controlling an information processing apparatus, the information processing apparatus including a plurality of electronic parts including an arithmetic processing unit, a control device that controls operations of the plurality of electronic parts, and a memory device, the method comprising:
detecting that a size of a first area allocated in the memory device and retaining setting information of the plurality of electronic parts is different from a size of a setting information area that is newly specified in response to a change in a function of the information processing apparatus;
allocating, in response to detection, a second area that is to retain the setting information in place of the first area in the memory device, the second area serving as the setting information area;
storing, in the second area, valid setting information extracted from the first area; and
deleting the first area from the memory device after the valid setting information is stored in the second area,
the detecting, the allocating, the storing, and the deleting being performed by the control device.
